(19) United States
(12) Patent Application Publication
(10) Pub. No.: US 2026/0147606 A1
(43) Pub. Date: May 28, 2026

(54) EXCEPTION CONTROL

(71) Applicant: Arm Limited, Cambridge (GB)

(72) Inventor: Michael John Williams, Ely (GB)

(73) Assignee: Arm Limited, Cambridge (GB)

(21) Appl. No.: 19/114,673

(22) PCT Filed: Aug. 1, 2023
(86) PCT No.: PCT/GB2023/052035

§ 371 Date: Mar. 24, 2025

(30) Foreign Application Priority Data
Sep. 28, 2022 (GB) 2214155.0

(51) Int. Cl. G06F 9/48; G06F 11/07

(52) U.S. Cl. CPC G06F 9/4831; G06F 11/0781; G06F 2209/481

(57) ABSTRACT

Exception control circuitry (40) controls taking of exception by processing circuitry (4), depending on control information stored in at least one register (14), the control information including masking control information settable to a masked state or unmasked state; and trap-masked-exception control information settable to an untrapped state or trapped state. In response to a given exception of a maskable class of exceptions, in at least one scenario when the masking control information is in the masked state and a current exception level is less privileged than a predetermined trap target exception level, the exception control circuitry controls whether to trap the given exception to the predetermined trap target exception level depending on whether the trap-masked-exception control information is in the trapped state. When the masking control information is in the unmasked state, a target exception level for handling the given exception is selected independent of the trap-masked-exception control information.

The present technique relates to the field of data processing. More particularly, it relates to exception handling.

While performing data processing, processing circuitry may encounter an exception which is an event which requires the normal flow of program execution to be interrupted so that processing can switch to an exception handler to deal with the event that caused the exception. For example, an exception may arise for a number of reasons, such as execution of an undefined instruction, an address fault arising due to a memory access for which no virtual-to-physical address translation mapping is defined or for which a memory access permission check fails, or the occurrence of an external event such as a memory system error or detection of an interrupt event signalled by an external device or peripheral.

At least some examples provide an apparatus comprising: processing circuitry to perform data processing in one of a plurality of exception levels supported by the processing circuitry; and exception control circuitry to control taking of exceptions by the processing circuitry, depending on control information stored in at least one register, the control information including at least: masking control information settable to one of a masked state and an unmasked state; and trap-masked-exception control information settable by software to one of an untrapped state and a trapped state; in which: in response to a given exception of a maskable class of exceptions which are maskable based on setting the masking control information to the masked state, the exception control circuitry is configured to: determine whether the masking control information is in the masked state; in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and in a case when the masking control information is in the unmasked state and the given exception is determined not to be masked, select a target exception level for handling the given exception, the target exception level being selected independent of the trap-masked-exception control information.

At least some examples provide computer-readable code for fabrication of the apparatus described above. The computer-readable code can be stored on a storage medium. The storage medium may be a transitory or non-transitory storage medium.

At least some examples provide a method comprising: performing data processing in one of a plurality of exception levels supported by the processing circuitry; and controlling taking of exceptions by the processing circuitry, depending on control information stored in at least one register, the control information including at least: masking control information settable to one of a masked state and an unmasked state; and trap-masked-exception control information settable by software to one of an untrapped state and a trapped state; in which: in response to a given exception of a maskable class of exceptions which are maskable based on setting the masking control information to the masked state, the method comprises: determine whether the masking control information is in the masked state; in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and in a case when the masking control information is in the unmasked state and the given exception is determined not to be masked, select a target exception level for handling the given exception, the target exception level being selected independent of the trap-masked-exception control information.

At least some examples provide a computer program comprising instructions which, when executed by a host data processing apparatus, control the host data processing apparatus to provide an instruction execution environment for executing target code, the computer program comprising: processing program logic to simulate execution of instructions of the target code in one of a plurality of exception levels; and exception control program logic to simulate taking of exceptions, depending on control information stored in at least one storage location of the host data processing apparatus representing at least one register of a target instruction set architecture used by the target code, the control information including at least: masking control information settable by software to one of a masked state and an unmasked state; and trap-masked-exception control information settable by software to one of an untrapped state and a trapped state; in which: in response to a given exception of a maskable class of exceptions which are maskable based on software setting the masking control information to the masked state, the exception control program logic is configured to: determine whether the masking control information is in the masked state; in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and in a case when the masking control information is in the unmasked state and the given exception is determined not to be masked, select a target exception level for handling the given exception, the target exception level being selected independent of the trap-masked-exception control information.

The computer program can be stored on a storage medium. The storage medium may be a transitory or non-transitory storage medium.

Further aspects, features and advantages of the present technique will be apparent from the following description of examples, which is to be read in conjunction with the accompanying drawings, in which:

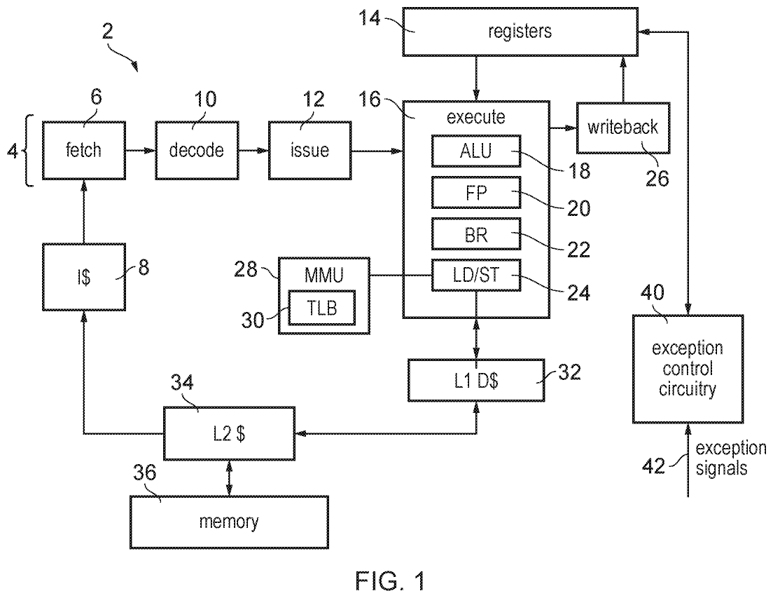

FIG. 1 schematically illustrates an example of a data processing apparatus;

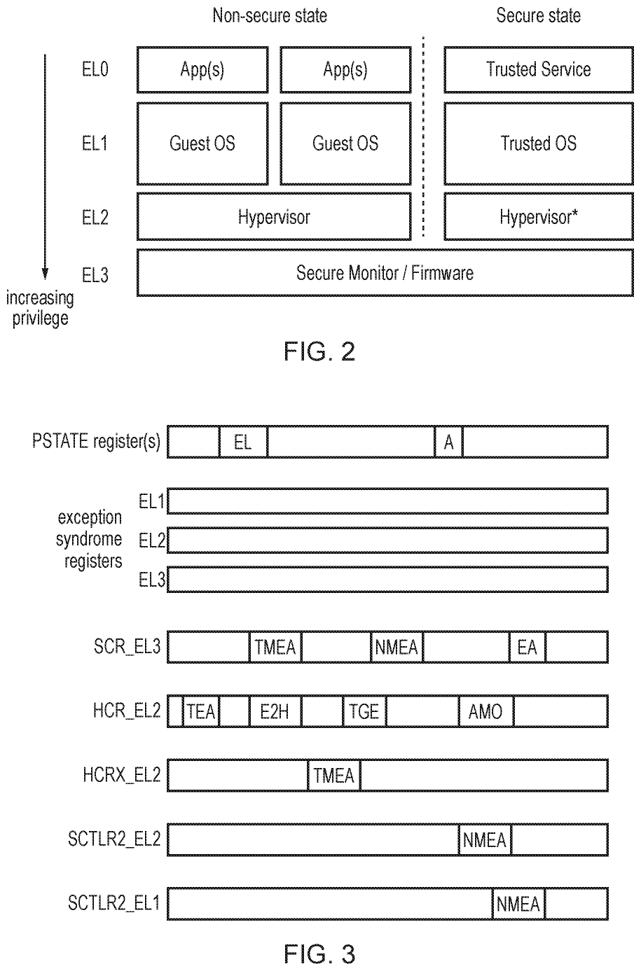

FIG. 2 illustrates a number of exception levels in which processing circuitry can perform data processing;

FIG. 3 illustrates control information stored in registers;

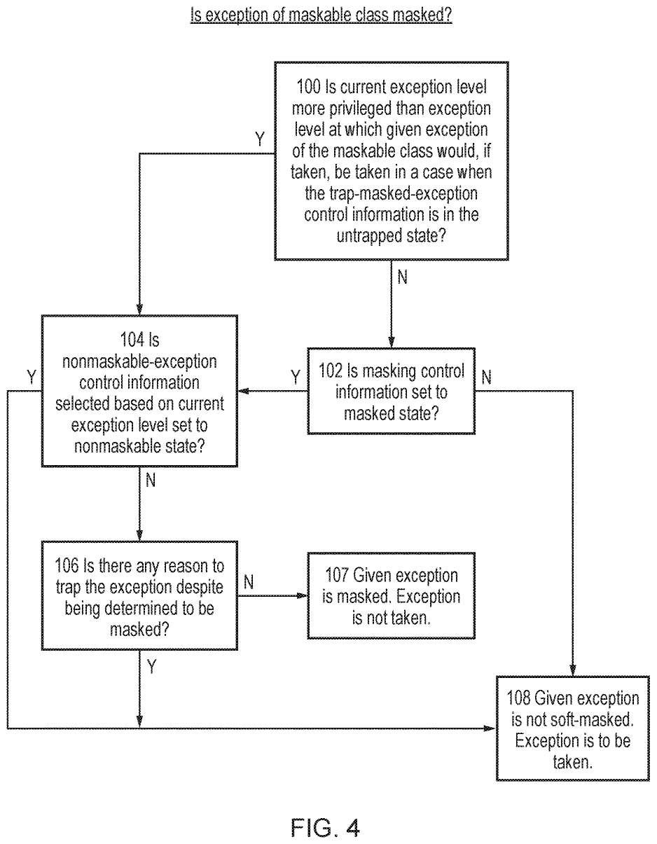

FIG. 4 is a flow diagram illustrating determination of whether a given exception of a maskable class of exceptions should be masked;

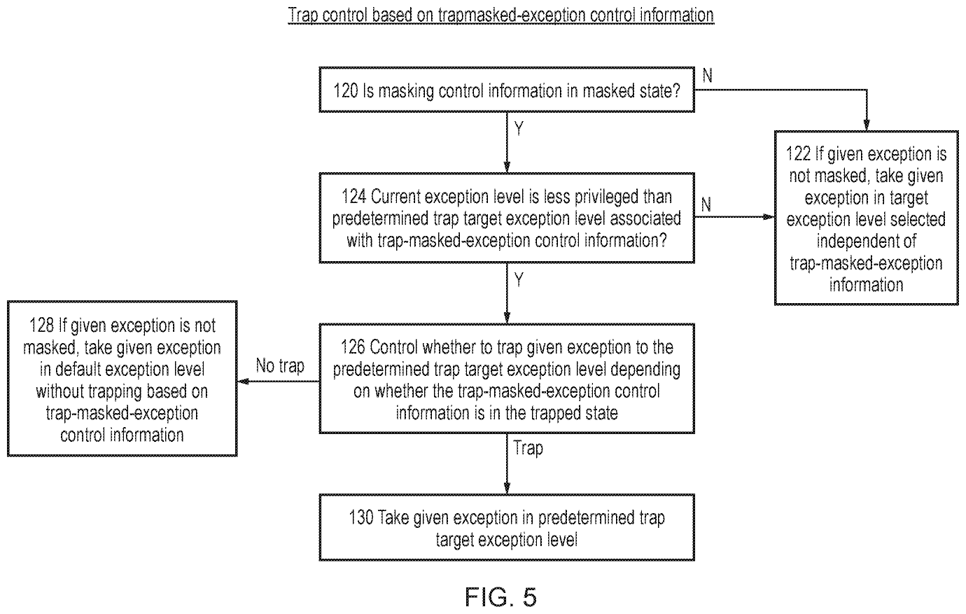

FIG. 5 is a flow diagram illustrating determination of whether to trap the given exception to a predetermined trap target exception level, depending on whether masking control information is in a masked state and trap-masked-exception control information is in a trapped state;

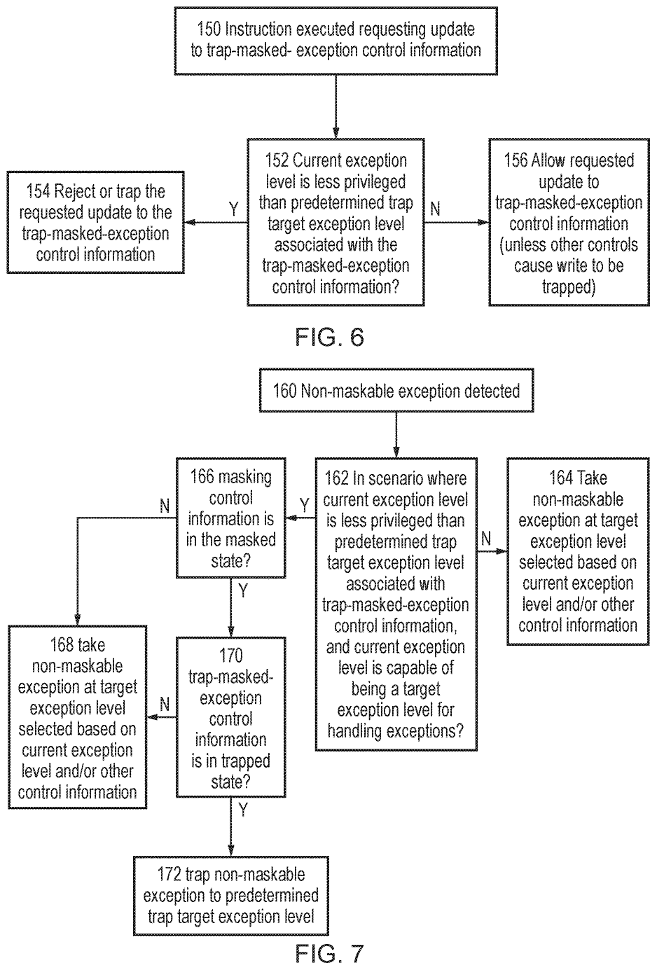

FIG. 6 is a flow diagram illustrating control of updates to the trap-masked-exception control information;

FIG. 7 is a flow diagram illustrating control of whether an exception of a non-maskable class of exceptions is trapped to the predetermined trap target exception level based on the trap-masked-exception control information;

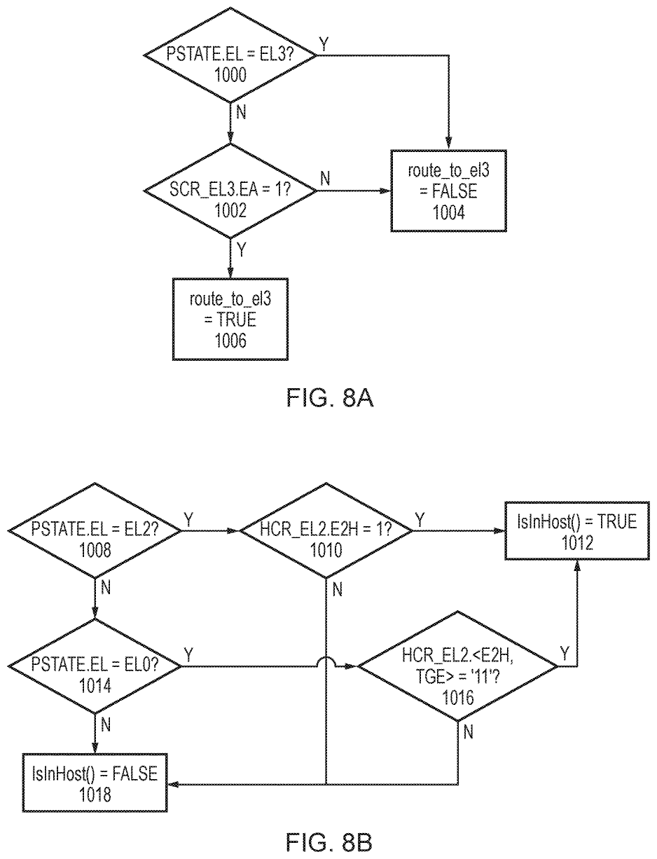

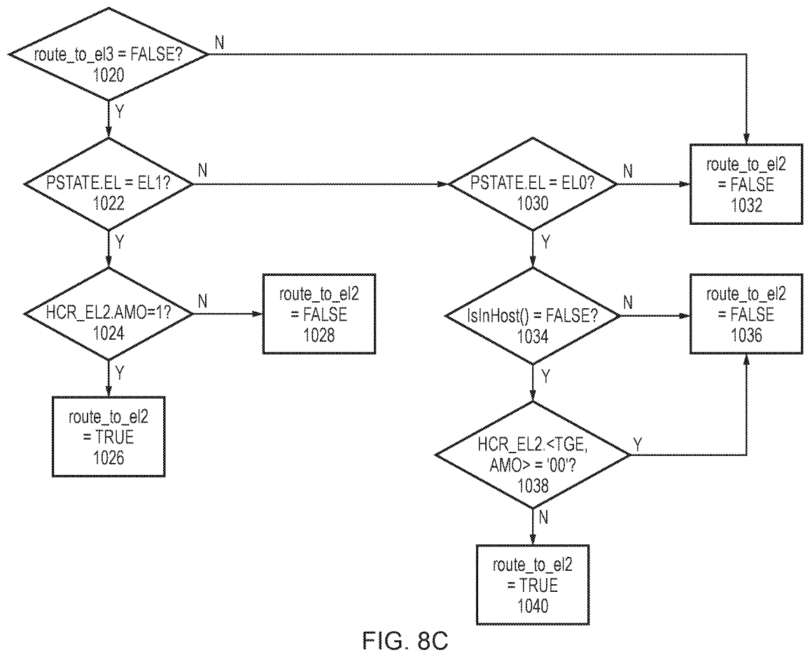

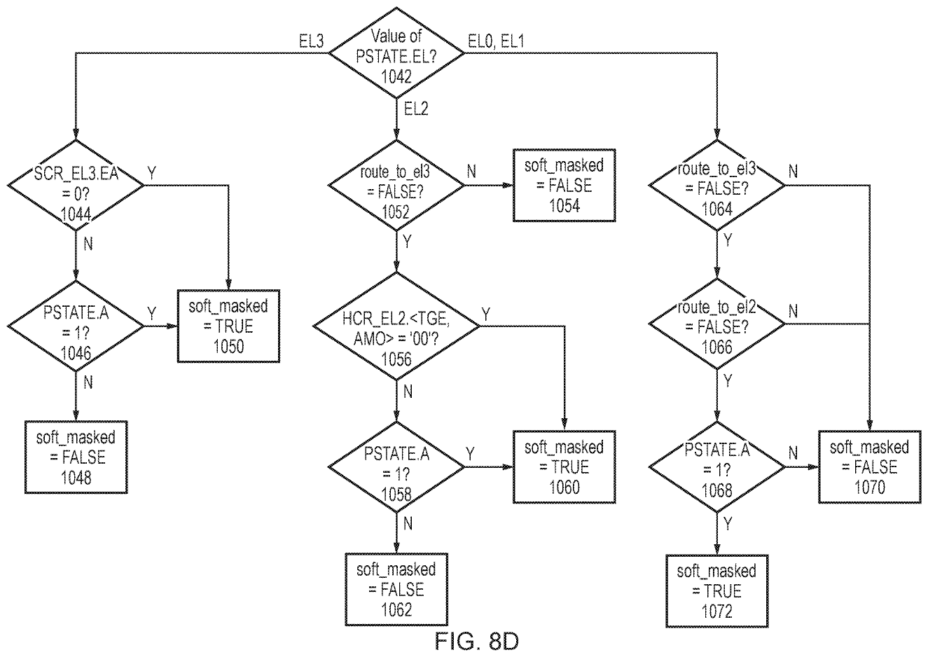

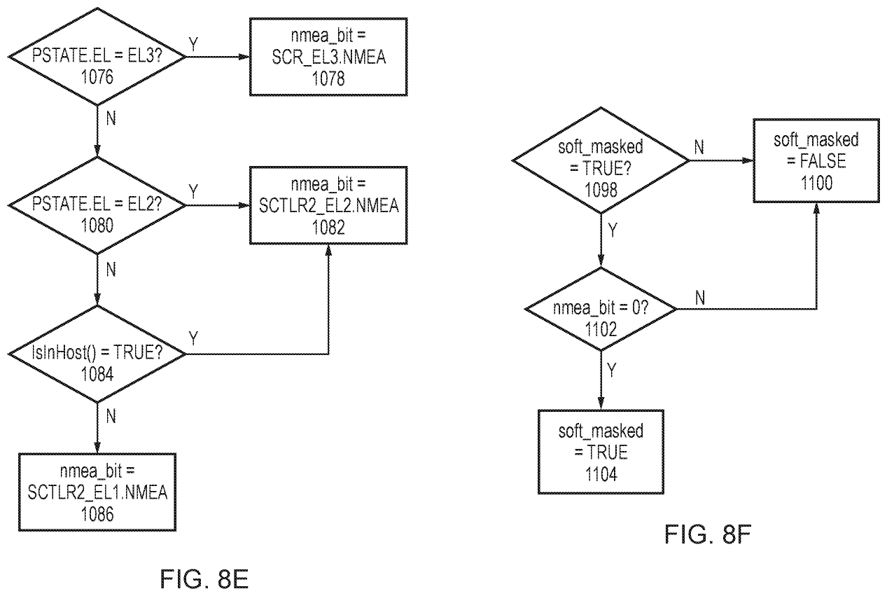

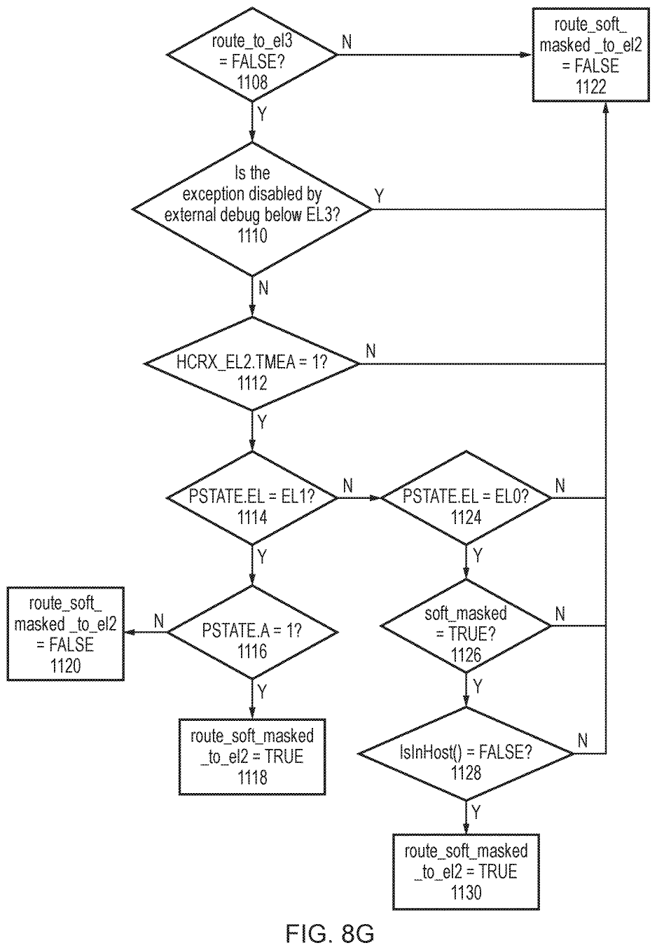

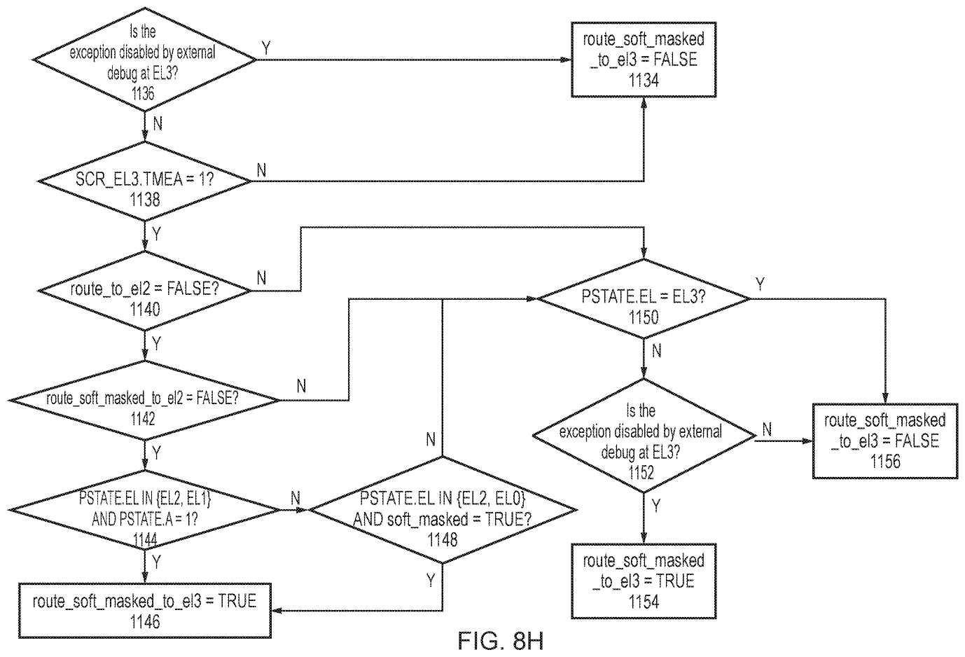

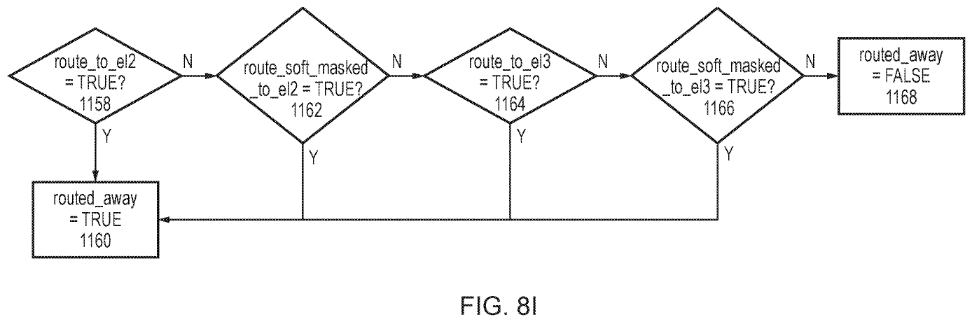

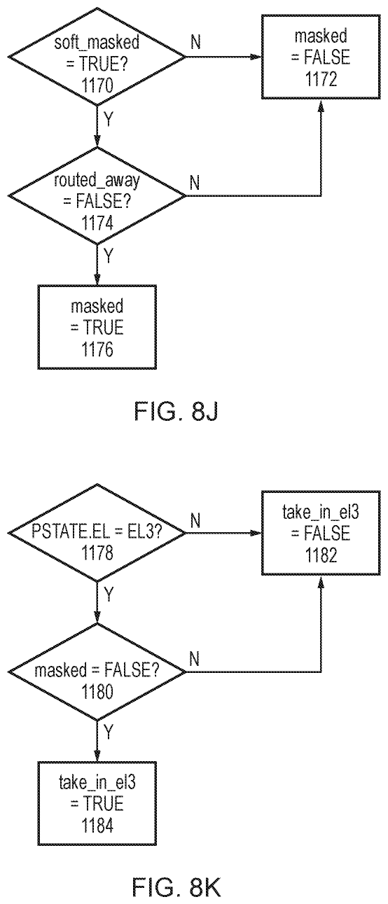

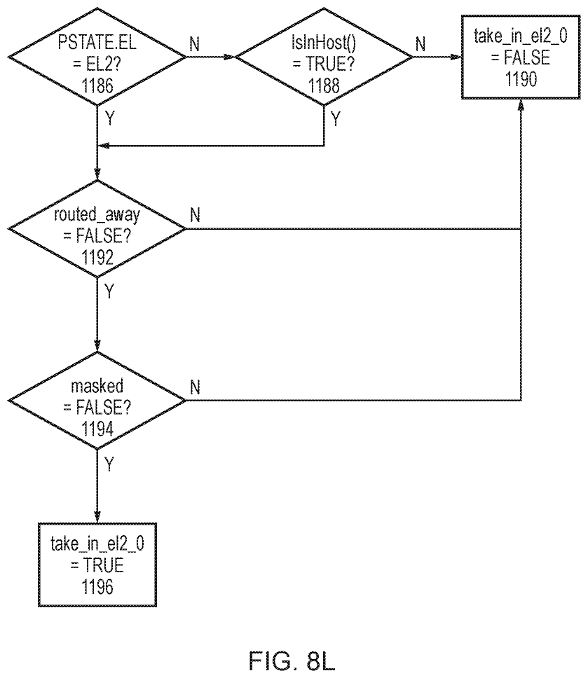

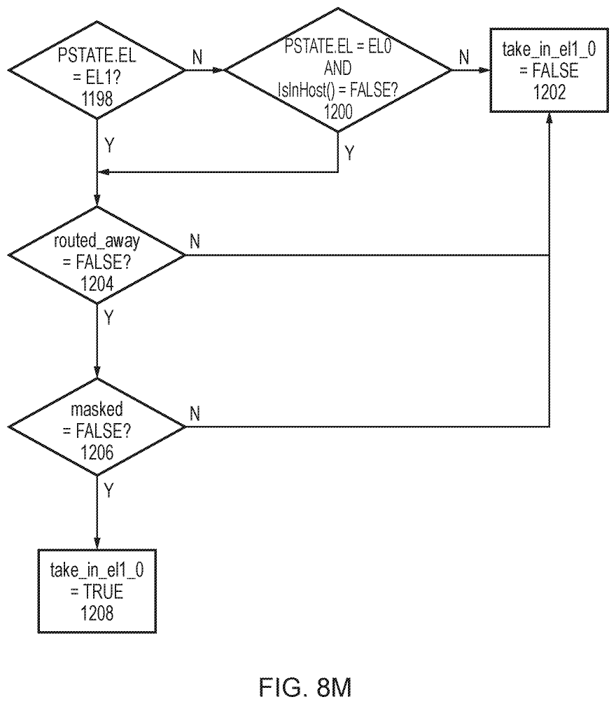

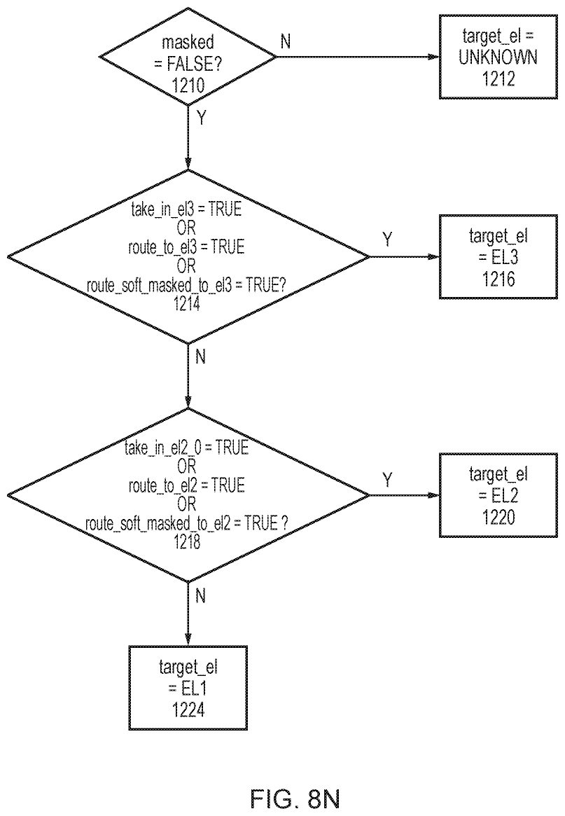

FIGS. 8A to 8O illustrate a specific example of determining whether a given exception of the maskable class of exceptions should be masked, and if not masked, which exception level is the target exception level at which the given exception is taken;

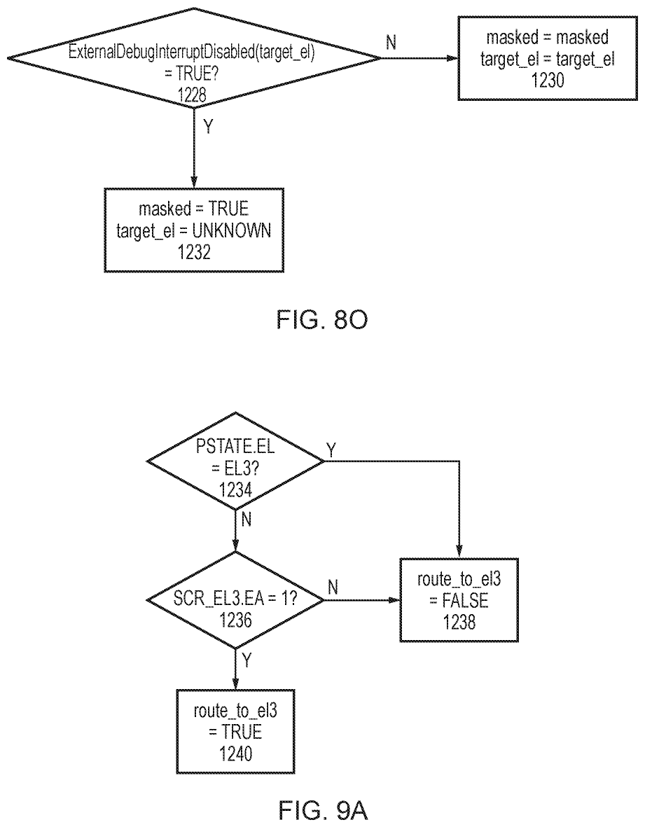

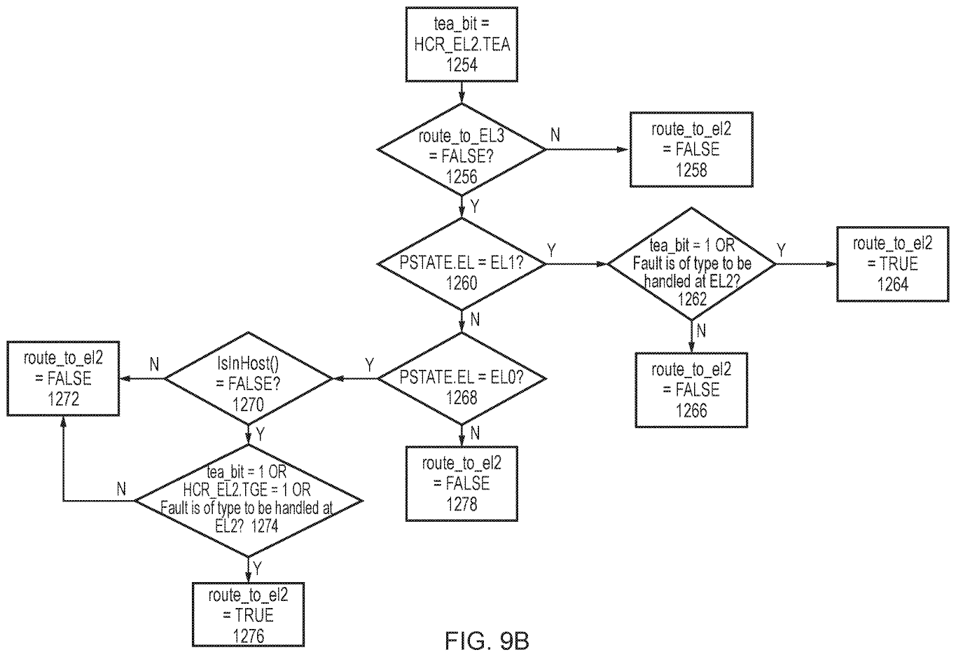

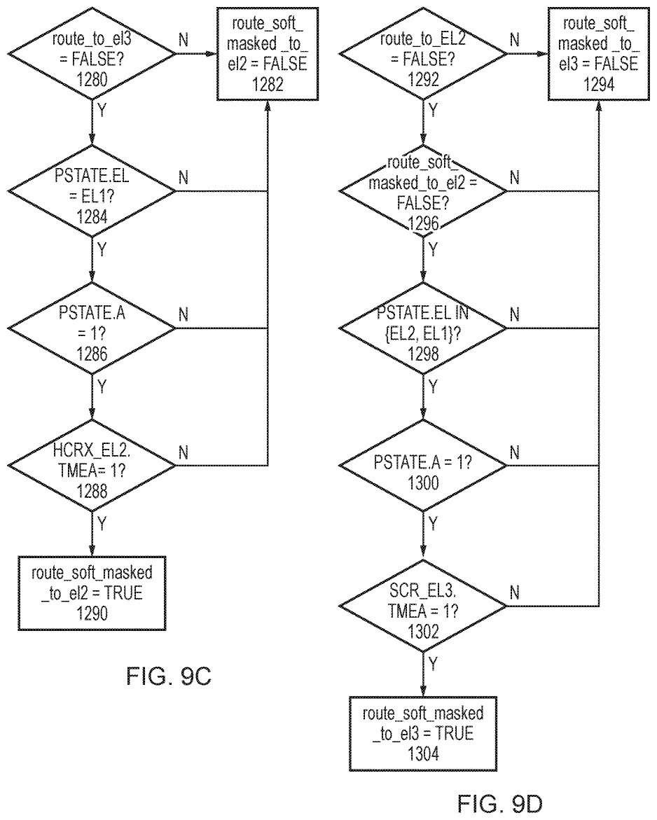

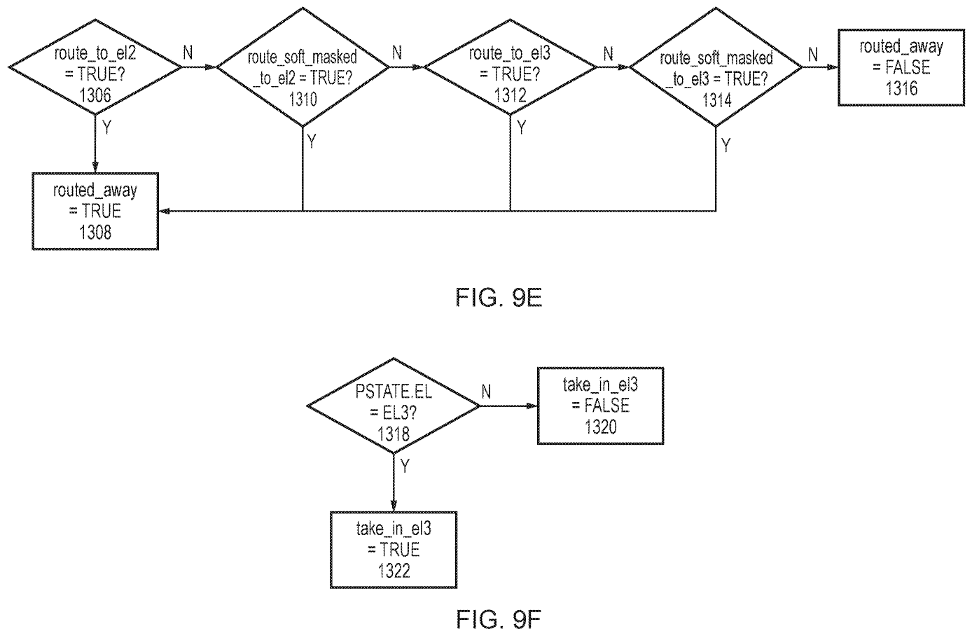

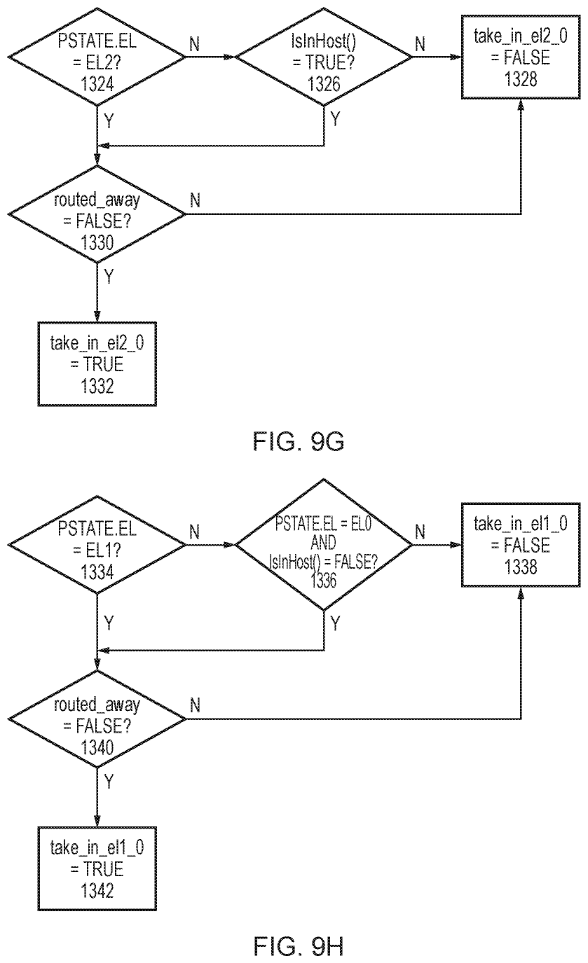

FIGS. 9A to 9I illustrate a specific example of determining the target exception level for an exception of the non-maskable class of exceptions;

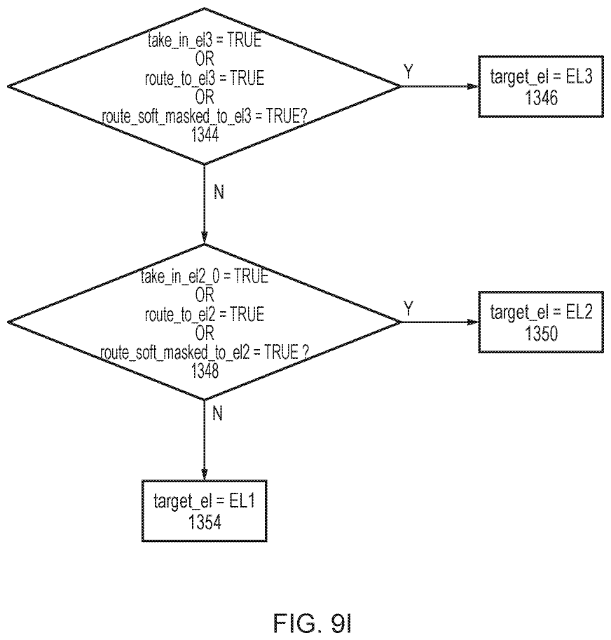

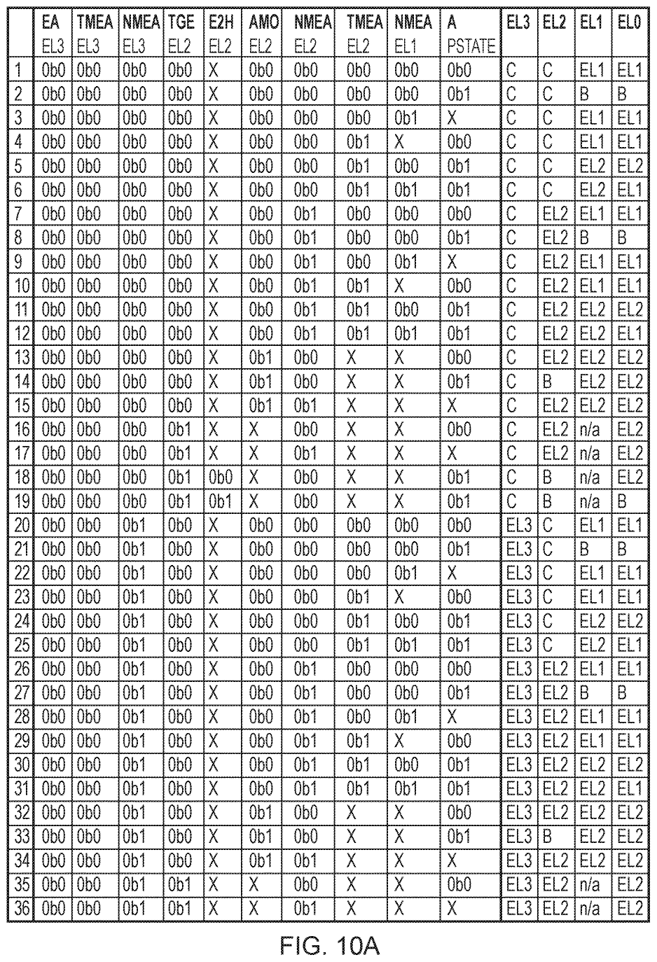

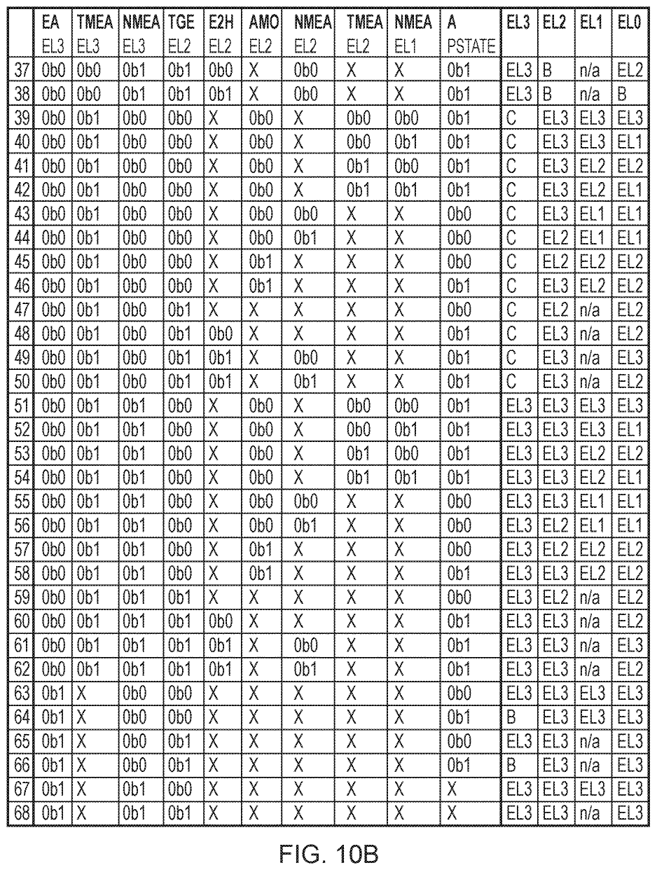

FIGS. 10A and 10B is a table illustrating whether a given exception of the maskable class is masked and, if not masked, which exception level the given exception is taken in, depending on the current exception level at the time the given exception occurs and the control information;

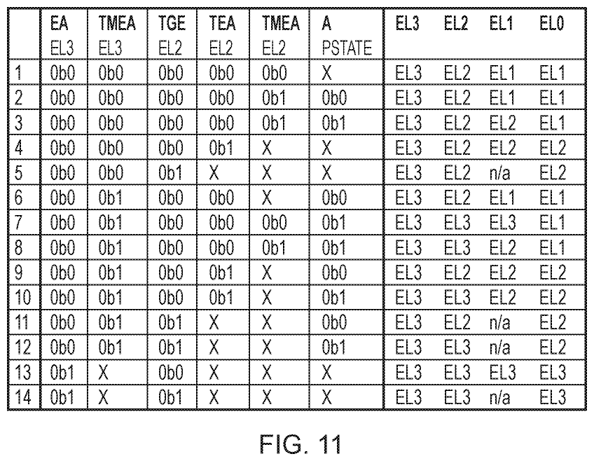

FIG. 11 is a table illustrating selection of the target exception level for the non-maskable class, depending on the current exception level at the time the given exception occurs and the control information; and

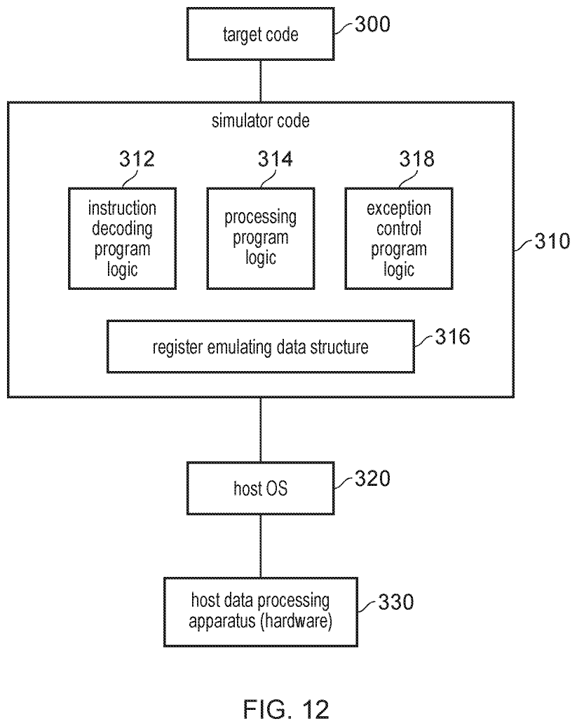

FIG. 12 illustrates a simulation example.

An apparatus has processing circuitry for performing data processing in one of a number of exception levels, and exception control circuitry to control taking of exceptions by the processing circuitry, depending on control information stored in at least one register. The control information influences whether an exception is masked or taken, and if taken, which exception level is the target exception level in which the exception is taken.

The control information includes masking control information settable to one of a masked state and an unmasked state. The masking control information could be set to the masked state automatically by hardware of the processing circuitry or exception control circuitry, in response to certain events (e.g. the masking control information can be set to a masked state in response to taking of an exception), and/or can be set by software executing at a given exception level to control whether a maskable class of exceptions are masked, to prevent them from being taken at the given exception level. If set in hardware on taking an exception, software can control the timing of when the masking control information is cleared to the unmasked state. For example, an instruction may be supported in the instruction set architecture, to allow software to trigger setting the masking control information to the masked or unmasked state as desired. If set to the masked state by software, software can choose to set the masking control information to the masked state for any arbitrary reason when it is desired to disable taking of exceptions for a time. Regardless of whether the masking control information is set in hardware or software, one reason for masking exceptions can be to preserve state information associated with the processing currently being performed by the software, which might be overwritten if an exception was taken.

However, other software executing on the processing circuitry (e.g. supervisory software such as a hypervisor or security monitor) may consider the maskable class of exceptions to be important exceptions that should be dealt with promptly, regardless of whether the processing circuitry (either in hardware or under control of software) when operating at a less privileged exception level has set the masking control information to the masked state. For example, there could be a concern, if the maskable class of exceptions represent detection of an error, that delaying handling of the exception due to masking based on the masking control information could risk the error propagating so that the problem becomes worse (e.g. an erroneous value stored in memory might get processed by other operations to propagate the error to other locations in memory). One approach for ensuring that the maskable class of exceptions are dealt with promptly can be to provide a control which software at a more privileged exception level can set to indicate that the maskable class of exceptions should be taken at that more privileged exception level, to override the masking based on masking control information even if the masking control information is in the masked state. However, a problem with this approach is that when this control is set, handling of the maskable class of exceptions is always taken away from the normal default level for handling the exception, which can increase complexity of software development because more cooperation may be required between different software developers developing the software executing at different exception levels.

In the examples discussed below, the control information includes trap-masked-exception control information settable by software to one of an untrapped state and a trapped state. In response to a given exception of a maskable class of exceptions which are maskable based on setting the masking control information to the masked state, the exception control circuitry is configured to: determine whether the masking control information is in the masked state; in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and in a case when the masking control information is in the unmasked state and the given exception is determined not to be masked, select a target exception level for handling the given exception, the target exception level being selected independent of the trap-masked-exception control information.

Hence, the trap-masked-exception control information provides an architectural control option which can be used to configure the exception handling circuitry so that, in the case when the masking control information has been set to the masked state, the exception can be trapped to a predetermined trap target exception level, to reduce delays in handling the exception. However, this trapping based on the trap-masked-exception control information is conditional on the masking control information being set to the masked state. In the case when the masking control information is in the unmasked state and the given exception is not being masked, the exception can be taken in a target exception level which is selected independent of the trap-masked-exception control information. As, in practice, the masking control information is typically set to the masked state for a relatively small fraction of execution time, this can greatly reduce the number of occasions on which the maskable class of exceptions has to be trapped to a more privileged exception level than the default level which would normally take the exception. Compared to a control option which indicates that all exceptions of the maskable class should be trapped to a more privileged exception level (regardless of the state of the masking control information), this allows a larger fraction of exceptions to be handled at a less privileged exception level, enabling “kernel-first” exception handling where lower privilege software can handle the maskable class of exceptions in the majority of cases (rather than “firmware-first” exception handling where more privileged code typically handles most exceptions). Kernel-first exception handling is often preferred as it can simplify software development in comparison to firmware-first exception handling. Hence, processors supporting an instruction set architecture which supports the trap-masked-exception control information are improved in comparison to processors not supporting the trap-masked-exception control information, as they are simpler for software developers to develop software for.

In response to an instruction which requests an update to the trap-masked-exception control information being executed at a less privileged exception level than the predetermined trap target exception level associated with the trap-masked-exception control information, the processing circuitry may reject or trap the requested update to the trap-masked-exception control information. Hence, the trap-masked-exception control information can be restricted to being set by software executing at the more privileged exception level to which the exception would be trapped (or can be set by an even more privileged exception level than that exception level). Hence, the trap-masked-exception control information can be seen as an architectural control option enabling more privileged code to override the preference (associated with operations at a less privileged exception level) for masking the maskable class of exception based on the masking control information being in the masked state.

In some examples, there may only be a single item of trap-masked-exception control information, which controls whether the trap dependent on masking control information is taken to a particular exception level.

However, it can be useful to provide multiple items of trap-masked-exception control information, each associated with a respective one of a plurality of predetermined trap target exception levels. The exception control circuitry may control whether, in at least one scenario where the given exception occurs when the masking control information is in the masked state and the current exception level is less privileged than a given one of the plurality of predetermined trap target exception levels, the given exception is trapped to the given one of the plurality of predetermined trap target exception levels, depending on whether a corresponding item of trap-masked-exception control information associated with that given one of the plurality of predetermined trap target exception levels is in the trapped state. By providing multiple items of trap-masked-exception control information which can be set by more privileged software at different exception levels, this gives multiple pieces of more privileged software (e.g. a hypervisor and security monitor code) separate control over whether, in the case when the masking control information is set to the masked state, the exception should be trapped rather than being masked. This can provide more flexibility for different software providers to influence the way in which the maskable class of exceptions are handled.

In at least one scenario where the given exception occurs when the masking control information is in the masked state, at least two items of trap-masked-exception control information are in the trapped state, and one or more conditions for trapping to the predetermined trap target exception level are satisfied for each of said at least two items of trap-masked-exception control information: the exception control circuitry is configured to trap the given exception to the predetermined trap target exception level associated with a selected item of trap-masked-exception control information; and the selected item of trap-masked-exception control information comprises one of said at least two items of trap-masked-exception control information for which there is a smallest difference in privilege between the current exception level and the associated predetermined trap target exception level. Hence, if more than one item of trap-masked-exception control information has been set to the trapped state (e.g. by software at different exception levels), if the exception is trapped based on the trap-masked-exception control information, it is taken to the least privileged of the associated predetermined trap target exception levels associated with those items of trap-masked-exception control information that have been set to the trapped state. This may be seen as counter-intuitive, as it is different to other exception handling controls which, if there are conflicting controls set by software at different exception levels, one would normally assume that the control set at a more privileged exception level should take precedence. However, allowing the item of trap-masked-exception control information associated with the less privileged exception level to take precedence even if a more privileged exception level has also set trap-masked-exception control information to the trapped state can be useful because taking the exception in the least privileged exception level available to take the exception can simplify software development.

In a case when the trap-masked-exception control information is in the untrapped state, the exception control circuitry may determine whether the given exception is masked depending at least on whether the masking control information is in the masked state. Whether the given exception is masked may also depend on other factors. For example, in the case when the trap is taken based on the trap-masked-exception control information, the exception is not masked even though the masking control information is in the masked state.

Also, there can also be other reasons for masking exceptions, which could for example be based on the current privilege level at the time of the exception occurring. For example, the exception control circuitry may determine whether the given exception is to be masked depending on whether the current exception level is more privileged than an exception level at which the given exception would be taken if the exception level is taken when the trap-masked-exception control information is in the untrapped state. This is useful because it can be assumed that, if currently in a more privileged exception level than the exception level that would ordinarily handle the exception (not considering trapping based on the trap-masked-exception control information), then the current processing may be considered more important than handling of the exception, and so the exception can be implicitly considered masked irrespective of whether the masking control information is in the masked state.

Also, even if the masking control information is in the masked state, this does not necessarily always mean that the exception is masked in the absence of the trap based on the trap-masked-exception control information. For example, as explained in more detail below, it is also possible to provide an architectural control option which allows software to express that, at least in some scenarios, the maskable class of exceptions should be treated as if it is non-maskable, so that the given exception may not be masked even if the masking control information is in the masked state.

Hence, it will be appreciated while, in general, in a case when the trap-masked-exception control information is in the untrapped state, the exception control circuitry is configured to determine whether the given exception is masked depending at least on whether the masking control information is in the masked state, in some implementations the determination of whether the exception is actually masked may also consider several other parameters.

In some examples, the control information comprises non-maskable-exception-control information which is settable to one of a non-maskable state and a maskable state to indicate whether or not exceptions of the maskable class are maskable; and in at least one scenario when the non-maskable-exception-control information is in the non-maskable state, the exception control circuitry is configured to determine that the given exception is not to be masked, even when the masking control information is set to the masked state. This control can be useful to allow more privileged software to express a preference that the maskable class of exceptions should be treated as non-maskable to ensure they are dealt with more promptly, irrespective of whether the masking control information has been set to the masked state.

In a scenario when the given exception occurs when the current exception level is a least privileged exception level, the non-maskable-exception control information is in the non-maskable state, and the given exception would be taken to a next least privileged exception level that is enabled for taking the given exception in a case when the given exception is not masked and the trap-masked-exception control information is in the untrapped state, the exception control circuitry is configured to control taking of the given exception in the next least privileged exception level, without trapping to the predetermined trap target exception level, even when the trap-masked-exception control information is in the trapped state. Hence, in a case when the current exception level is the least privileged level, the non-maskable-exception control information being in the non-maskable state also overrides any trapping based on the trap-masked-exception control information. Note that the next least privileged exception level that is enabled for taking the given exception can vary based on other control information. For example, control information specifying whether the system is in a guest operating system regime (where a hypervisor manages the guest operating system but does not perform operating system functions itself) or a host operating system regime (where a hypervisor also manages applications and performs operating system functions) may control whether an exception level used for the guest operating system in the guest operating system regime is disabled in the host operating system regime, so the next least privileged exception level that is enabled can be a kernel-level exception level (at which the guest operating system executes) in the guest operating system regime and can be a hypervisor-level exception level (in which the hypervisor/host operating system executes) in the host operating system regime.

When the current exception level is not the least privileged exception level, the non-maskable-exception control information being in the non-maskable state may override the masking itself, but not override any trap determined to be required based on the trap-masked-exception control information being in the trapped state and the masking control information being in the masked state. This is because the setting of the masking control information to the masked state expresses that there is a preference (given the current state of processing at the default exception level to which the exception would normally by default be taken) for the exception not to be taken to preserve some state that might be overwritten on taking the exception, and so it can still be preferable to take the exception at a higher level by triggering the trap to the predetermined trap target exception level, even if the exception would not actually have been masked.

In some examples, the control information comprises a plurality of items of non-maskable-exception-control information associated with different exception levels; and the exception control circuitry determines whether the given exception is masked depending on one of the plurality of items of non-maskable-exception-control information selected based on the current exception level. This can provide flexibility for different providers of software executing at different exception levels to express independent preferences on whether to allow masking of the maskable class of exceptions.

Hence, it will be appreciated that the precise determination of whether or not to take the trap to the predetermined trap target exception level may depend on a number of factors, in addition to the masking control information and trap-masked-exception control information, such as (in some implementations) the current exception level and (in at least one exception level) the current state of non-maskable-exception control information.

In some implementations, there may also be other (optional) controls which override the trap-masked-exception control information, so that even if the conditions described above for taking the trap are satisfied (the masking control information is in the masked state, the current exception level is less privileged than a predetermined trap target exception level associated with the trap-masked-exception control information, and the trap-masked-exception control information is in the trapped state), the trap to the predetermined trap target exception level might still not be taken (e.g. because another control has specified to trap the maskable class of exceptions to a different exception level).

For example, the control information may comprise at least one further item of trap control information settable by software to one of a trapped state and an untrapped state; the exception control circuitry may control whether to trap exceptions of at least the maskable class to a particular exception level, depending on whether the further item of trap control information is in the trapped state; and the at least one further item of trap control information may take precedence over the trap-masked-exception control information, so that in a case when the further item of trap control information is in the trapped state, the exception control circuitry is configured to trap the exception to the particular exception level based on the further item of trap control information regardless of whether the trap-masked-exception control information is in the trapped state. For example, this further item of control information may be similar to the control described above for comparison, which means that the maskable class of exceptions can be trapped to a certain more privileged exception level, irrespective of whether the masking control information is in the masked state. The use of the trap-masked-exception control information may therefore be relevant in the case when the at least one further item of trap control information is in the untrapped state, but not when the at least one further item of trap control information is in the trapped state.

In some cases, at least one of the further items of trap control information could be specific to the maskable class of exceptions, with another class of exceptions being unaffected by that item of trap control information.

Also, it is possible for at least one of the further items of trap control information to be a more general control which affects handling of both the maskable class of exceptions and at least one other class of exceptions.

Hence, there are a large number of ways in which the trap-masked-exception control information could be used, depending on which additional architectural control settings are supported and how the information defining those architectural control settings has been set. In general, it is useful to provide trap-masked-exception control information which, in at least one scenario where the given exception occurs when the masking control information is in the masked state and a current exception level is less privileged than a predetermined trap target exception level associated with the trap-masked-exception control information, controls a trap to a predetermined trap target exception level depending on whether the trap-masked-exception control information is in the trapped state, but which in the case when the masking control information is in the unmasked state does not influence selection of the target exception level in a case when the maskable exception is not being masked. However, it is not essential for the trap-masked-exception control information to be considered in all scenarios in which exceptions could occur.

The maskable class of exceptions can be any class of exceptions which can optionally be masked out but which might sometimes need to be handled more promptly.

However, the techniques discussed above can be particularly useful in a case where the maskable class of exceptions comprises asynchronous system error exceptions indicative of a deviation from correct service. An error exception indicates a deviation from correct service, e.g. where the apparatus itself (or an external apparatus) did not comply with its correct functional specification. This may differ from other causes of fault (such as memory management faults or undefined instruction errors) where the hardware system itself is functioning correctly but software-configured information has been wrongly set (e.g. an undefined instruction has been provided, page table mappings have not been specified for an address accessed in memory, or memory access permissions have been violated (e.g. a write to a read-only region of memory)). In many cases, an error exception may occur following a memory system access, but they could also occur for other reasons (e.g. a failure in a register of the processing circuitry). An asynchronous exception is an exception which is not able to be attributed to a specific point in the instruction stream being executed. For example, for an asynchronous exception, unlike a synchronous exception that can be attributed to a specific point in the instruction stream, it may not be possible to clearly determine which instructions are older instructions which are unaffected by the error and younger instructions which are potentially affected by the error. While asynchronous system error exceptions can have a number of causes, a common example of an asynchronous system error can be a data abort triggered by a writeback of dirty data from a cache line to external memory.

Such errors may be desired to be dealt with relatively promptly as delaying handling of the asynchronous system error exception can risk the error propagating causing a greater problem. However, it may also be desirable to support the ability for software or hardware to specify that error exceptions should be masked using the masking control information, to prevent important state information being overwritten on taking the exception. The provision of the trap-masked-exception control information allows a compromise where, in the majority of cases when the asynchronous system error exceptions are not being masked, the exceptions can be dealt with kernel-first, but there is a safety net to allow firmware-first handling of the exception in the case where the masking control information has been set to the masked state.

The exception control circuitry may also support a non-maskable class of exceptions which are unable to be masked based on setting the masking control information to the masked state. One might expect that, as this class of exceptions cannot be masked based on the masking control information, the problem discussed above of this masking causing delays to handling the exception does not arise, and so there is no need to trigger any trap based on the trap-masked-exception control information. However, the inventor recognised that, even though the non-maskable class of exceptions will not actually be masked, the setting of the masking control information to the masked state may signal a preference that exceptions are not taken to preserve important processor state that might otherwise be overwritten on taking an exception. Therefore, even though the non-maskable class of exceptions are not maskable, it can still be useful to use the trap-masked-exception control information to control whether, in the case when the masking control information is in the masked state, a trap to the predetermined trap target exception level is taken. Therefore, in at least one scenario when the given exception occurs when the masking control information is in the masked state, a current exception level is less privileged than the predetermined trap target exception level associated with the trap-masked-exception control information and the current exception level is an exception level that is capable of being a target exception level for handling exceptions, the exception control circuitry may control whether to trap the non-maskable exception to the predetermined trap target exception level depending on whether the trap-masked-exception control information is in the trapped state. This helps to reduce likelihood of important state being lost due to overwriting when an exception occurs at a time that the masking control information is in the masked state.

In a case when the current exception level is an exception level that is incapable of being a target exception level for handling exceptions (e.g. the least privileged exception level) then there is no need to trigger the trap of the non-maskable exception based on the trap-masked-exception control information.

The non-maskable class of exceptions may, for example, comprise synchronous external abort exceptions indicative of a deviation from correct service. Again, deviation from correct service may be caused by any of the example events described above for asynchronous system error exceptions, but in contrast to an asynchronous exception, a synchronous exception is one that is able to be attributed to a specific point in the instruction stream being executed. For example, the synchronous exception could be an error detected in the memory system (such as a failed error correction code check) following a demand memory access issued following execution of a specified instruction (rather than an error detected for a cache writeback which is more likely to be treated as an asynchronous error), which is therefore able to be attributed to a particular point in the instruction stream.

The apparatus may comprise a plurality of sets of one or more exception syndrome registers, each set of one or more exception syndrome registers to store exception syndrome information for exceptions taken in a respective one of the exception levels. Although software may choose to set the masking control information to the masked state for any arbitrary software-specific reason, a common reason for setting the masking control information to the masked state can be that a previous exception is being processed and it is undesirable for the information about the previous exception to be overwritten in the relevant syndrome register for the current exception level, if a subsequent exception was taken to that exception level. Hence, taking the trap to the predetermined trap target exception level can help protect the information in the set of one or more syndrome registers associated with the current exception level, while still allowing the exception to be taken promptly. Hence, the technique described above can be particularly useful in an architecture where there are banked sets of exception syndrome registers for specific exception levels allowing simultaneous register storage of exception information associated with exceptions being handled at different exception levels.

The techniques discussed above may be implemented in a hardware processor which has hardware circuit features providing the processing circuitry and the exception control circuitry as discussed above. The hardware apparatus may have registers provided in hardware to store the control information as discussed above.

However, in other examples, the technique may be implemented within a program for controlling a host data processing apparatus to provide an instruction execution environment for executing target code. The computer program providing the simulation may be stored on a storage medium. The storage medium may be a transitory storage medium or a non-transitory storage medium.

Such simulation computer programs can be useful for allowing target programs developed according to a target instruction set architecture to be executed on a host data processing apparatus which does not itself support the target instruction set architecture. This can be useful for a number of reasons, such as for allowing legacy code to execute on a newer device which does not support the architecture for which the code was developed, or for testing a target program, which is under development for a new instruction set architecture to be released in future, before any hardware devices supporting that new instruction set architecture are yet available. Whereas a hardware-implemented device may have hardware circuits providing the features discussed above, the software simulation may provide corresponding software features, such as program logic and data structures, which emulate the functionality of the corresponding hardware, so that the target program can execute above the simulation program to give the same results as if the target program was executed by a corresponding hardware device natively supporting the target instruction set architecture.

Hence, the computer program may have processing program logic and exception control program logic which functions in an analogous way to the processing circuitry and exception control circuitry discussed above. The exception control program logic may control exception handling based on control information stored in at least one storage location of the host data processing apparatus which represents at least one register of the target instruction set architecture used by the target code. Simulated exceptions of the maskable class may be handled in the way discussed above, with a trap to the predetermined trap target exception level being controlled based on the trap-masked-exception control information in the case when the masking control information is in the masked state. Hence, target code (which may include the respective pieces of software executing at different simulated exception levels) executing on the simulation program may see the same effects as if it was executing on a hardware apparatus supporting the same architectural control options as those discussed earlier.

FIG. 1 schematically illustrates an example of a data processing apparatus 2. The apparatus 2 has a processing pipeline 4 which provides processing circuitry for performing data processing in response to instructions. The processing pipeline 4 has a fetch stage 6 for fetching instructions to be executed from an instruction cache 8. A decode stage 10 decodes the fetched instructions to generate control signals for controlling subsequent stages of the pipeline 4 to perform the operations represented by the instructions. An issue stage 12 receives the decoded instructions and queues them while waiting for any required operands to be available in registers 14. When the required operands are determined to be available then the instructions are passed to an execute stage 16 which includes a number of execution units 18, 20, 22, 24 for performing processing operations in response to the instructions. The processing operations may use operands read from the registers 14 and generate a processing result which may be written back to the registers 14 by a write back stage 26 of the processing pipeline 4. Other examples may have a different arrangement of pipeline stages (e.g. a register rename stage for mapping architectural registers specified by instructions to physical registers provided in hardware could be included)

In this example, the execute stage 16 includes, as the execution unit, an arithmetic/logic unit (ALU) 18 for performing arithmetic or logical operations on integer operands, a floating-point unit 20 for performing floating-point operations for which at least one of an input operand and an output operand is represented in floating-point representation, a branch unit 22 for evaluating the outcome of branch instructions for triggering non-sequential program flow, and a load/store unit 24 for controlling access to memory. The load/store unit 24 may execute load instructions which control the load/store unit to load data from the memory system to the registers 14, or store instructions which control the load/store unit 24 to store data from the registers 14 to the memory system. It will be appreciated that the particular set of execute units 18 to 24 shown in the example of FIG. 1 is just one possible implementation and other implementations may have different sets of execute units. For example one or more of the types of execute units shown in FIG. 1 could be omitted, or one of these types could be duplicated so that several execute units of the same type may be provided. Also other types of execute unit may be provided dedicated to handling other classes of processing operation not shown in FIG. 1.

For the load/store operations performed by the load/store unit 24, virtual addresses specified by the load/store instructions may be translated into physical addresses by a memory management unit 28, based on address mappings defined in page table data obtained from page table structures within the memory system. A translation lookaside buffer (TLB) 30 may be provided to cache page table entries from the page table structures for faster access by the memory management unit 28.

In this example the memory system includes the level 1 instruction cache 8, a level 1 data cache 32, a shared level 2 cache 34 used for either instructions or data, and main memory 36. However, it will be appreciated that this is just one example of a possible cache hierarchy and other examples could have a greater number of cache levels or could have a different relationship between the instruction caching and the data caching.

Exception control circuitry 40 is provided for controlling exception handling for the processing apparatus 2. Exception signals 42 may be received by the exception control circuitry, to indicate when one of a number of exception conditions has occurred. The exceptions may include a number of types of exception. For example, the decode stage 10 could generate an undefined instruction exception when encountering a fetched instruction which corresponds to an undefined instruction encoding not supported by the apparatus 2. Also, the MMU 28 could generate an address fault exception if a load/store instruction specifies a target address which either does not have an address mapping defined in the page table structures, or which does have an address mapping defined but for which the corresponding address mapping specifies access permissions which are not satisfied by the software process which issued the load/store instruction. Also, exception signals 42 could be received indicating whether an external interrupt has occurred, for example due to receiving a message from an external device or peripheral, such as a message indicating that a user has pressed a button on the device in which the processing apparatus 2 is included, or that a network controller communicating with an outside network has received a message. The memory system may also generate an exception signal if a memory system error is detected, such as a failure of a check of a parity code or error correction code used to detect errors in stored data caused by events such as random bit flips due to particle strikes, ionising radiation or electronic component aging effects, bus errors due to incorrect control settings on a memory system bus, or other conditions which mean a requested memory system operation cannot be performed correctly. It will be appreciated that many different types of exceptions may be defined and the examples above are not exhaustive.

When an exception occurs, the exception control circuitry may use register state in the registers 14 to determine whether to take the exception, and if the exception should be taken, what operating state the processing circuitry should be in when taking the exception. If an exception is taken then the exception control circuitry 40 interrupts the processing currently being performed by the pipeline and controls the pipeline to switch to executing an exception handler, which may provide software instructions for responding to the event indicated by the exception type that occurred.

FIG. 2 is a diagram illustrating different execution states (also referred to as exception levels) in which the processing circuitry 4 can operate when executing instructions. In this example there are four exception levels EL0, EL1, EL2, EL3, where exception level EL0 is the least privileged exception level and exception level EL3 is the most privileged exception level. In general, when executing in a more privileged exception level, the processing circuitry may have access to some memory locations or registers 14 which are inaccessible to lower, less privileged, exception levels.

In this example, exception level EL0 is for executing applications which are managed by corresponding operating systems or virtual machines executing at exception level EL1. Where multiple virtual machines coexist on the same physical platform then a hypervisor may be provided operating at EL2, to manage the respective virtual machines. Although FIG. 2 shows examples where the hypervisor manages the virtual machines and the virtual machines manage applications, it is also possible for a hypervisor to directly manage applications at EL0 (in this case exception level EL1 may be disabled).

Although not essential, some implementations may implement separate hardware-partitioned secure and non-secure domains of operation for the processing circuitry. The data processing system 2 may have hardware features implemented within the processor and the memory system to ensure that data and code associated with software processes operating in the secure domain are isolated from access by processes operating in the non-secure domain. For example, a hardware architecture such as the TrustZone® architecture provided by Arm® Limited of Cambridge, UK may be used. Alternatively other hardware enforced security partitioning architectures could be used. Secure applications (trusted services) may operate in exception level EL0 in the secure domain and secure (trusted) operating systems or virtual machines may operate in exception level EL1 in the secure domain. In some implementations, there is no support for EL2 in the secure state and the hypervisor may execute solely in non-secure EL2. In other implementations, there may be support for a secure hypervisor executing in secure EL2 as indicated by the asterisk in FIG. 2. In some examples, a secure monitor program for managing transitions between the non-secure domain and the secure domain may be provided executing in exception level EL3. Other implementations could police transitions between the security domains in hardware so that the secure monitor program may not be needed.

FIG. 3 shows a subset of the registers 14. The registers include exception syndrome registers, which are banked to provide separate sets of one or more exception syndrome registers to store exception syndrome information for exceptions taken in respective exception levels EL1, EL2 and EL3 (the least privileged exception level EL0 is not capable of taking exception levels so does not require exception syndrome registers). For example, the syndrome information associated with a taken exception can include information about the cause of the exception (e.g. a fault type), information about an address associated with the exception, or any other information useful for enabling an exception handler to decide how to deal with the exception.

FIG. 3 also shows a subset of the control information which the exception control circuitry 40 can use to control handling of exceptions. It will be appreciated that FIG. 3 does not show all of the registers provided in the processor, and does not show all of the control state provided in those registers. Also, it will be appreciated that the particular layout of the control information across different registers can be varied, and the same information could be represented in different forms. For example, information shown in FIG. 3 in different registers could be stored in the same register, or information shown in the same register in FIG. 3 could be stored in different registers. Therefore, the particular register layout shown is not essential, and the same functionality of control options can be provided using other register layouts. The notation XXX_ELx.YYY refers to the field YYY provided within register XXX, and indicates that the least privileged exception level at which that register can be written to is exception level ELx. Writes to a register are rejected, or trapped to a higher exception level, if attempted at an exception level less privileged than the exception level ELx indicated in the register suffix.

In this particular example, the control information includes:
PSTATE.EL: an indication of the current exception level;
PSTATE.A: masking control information settable to one of a masked state (in this example, PSTATE.A=0b1) and an unmasked state (in this example, PSTATE.A=0b0). When in the masked state, this expresses a preference for asynchronous exceptions (including asynchronous memory system error exceptions—SError exceptions) targeting the current exception level to be masked to prevent them from being taken until PSTATE.A is cleared to the unmasked state, although this preference can be overridden by other control state options as shown below. For example, masking asynchronous system error exceptions can be useful to protect information (about a previous exception) stored in the exception syndrome registers which would otherwise be overwritten if another exception is taken in the same exception level as the previous exception. Although not shown in FIG. 3, the PSTATE register(s) may also include further mask fields for masking other classes of exception, other than asynchronous system error exceptions. However, the examples discussed below will refer to the asynchronous system error (SError) exceptions as a specific example of a maskable class of exceptions. Asynchronous system errors are exceptions signalled when an error (deviation from correct functioning of the system hardware) is detected which is not able to be attributed to a specific point in the executed instruction stream.
SCR_EL3.EA: an example of a further trap control, which when set to 0b1 causes certain classes of exceptions (e.g. synchronous external aborts and asynchronous system error (SError) exceptions) to be routed to EL3 instead of the exception level at which they would otherwise be handled when SCR_EL3.EA=0b0.
HCR_EL2.TEA: another example of a further trap control, which when set to 0b1 causes external abort exceptions occurring at EL0, EL1 or EL2 to be routed to EL2 (if not being routed to EL3 based on SCR_EL3.EA), instead of the exception level at which they would otherwise be handled when HCR_EL2.TEA=0b0 unless HCR_EL2.TGE or another control requires routing to EL2 or EL3.
HCR_EL2.TGE: another example of a further trap control, which indicates whether to “trap general exceptions” to EL2—if set to 0b0 there is no effect on execution at EL0, while when set to 0b1 exceptions that would ordinarily be routed from EL0 to EL1 are instead routed to EL2. This effectively disables EL1 from being available for taking exceptions, and software cannot reach EL1. If HCR_EL2.E2H is also 0b1, then EL1 is fully disabled and EL0 runs in the host operating system. If HCR_EL2.E2H is 0b0, then exceptions are not taken to EL1 but EL1 controls may still have an effect.
HCR_EL2.AMO: another example of a further trap control, which indicates whether physical system error (SError) exceptions should be routed to EL2. When HCR_EL2.AMO=0b1, SError exceptions are taken to EL2 unless they are routed to EL3 based on SCR_EL3.EA. This is not required when HCR_EL2.AMO is 0b0 (unless HCR_EL2.TGE or another control requires routing to EL2).
HCR_EL2.E2H: indicates whether a configuration for running a host operating system (Type 2 hypervisor) is supported at EL2, which can affect exception handling at lower levels such as EL0 (if a type 2 hypervisor is supported, some exceptions which would otherwise be handled at EL1 may be handled at EL2 instead). When HCR_EL2.E2H=0b1, the facilities to support a host operating system at EL2 are enabled. When HCR_EL2.E2H=0b0, the facilities to support a host operating system at EL2 are disabled.
SCR_EL3.NMEA, SCTLR2_EL2.NMEA, SCTLR2_EL1.NMEA: respective items of non-maskable-exception control information associated with exception levels EL3, EL2 and EL1 respectively, which are settable by software executing at those exception levels (or a more privileged exception level) to control whether SError exceptions are maskable using PSTATE.A to prevent them from being taken at those exception levels. These can each be set to one of a non-maskable state (e.g. 0b1) and a maskable state (e.g. 0b0). When in the non-maskable state, Serror exceptions can be taken at the corresponding exception level regardless of the value of PSTATE.A. When in the maskable state, Serror exceptions can be masked from being taken at the corresponding exception level based on PSTATE.A being set to the masked state (e.g. 0b1). More detail on how these controls affect handling of Serror exceptions is set out below.
SCR_EL3.TMEA, HCRX_EL2.TMEA: respective items of trap-masked-exception control information associated with EL3 and EL2 respectively, which can be set in a trapped state (e.g. 0b1) to control that, in a case when PSTATE.A is in the masked state (0b1) and the current exception level is less privileged than the corresponding exception level EL3 or EL2, an asynchronous Serror exception or a synchronous external abort exception is trapped to the corresponding exception level EL3 or EL2, or to an untrapped state (e.g. 0b0) where that trap does not occur. The TMEA controls are overridden by any trap to EL2 or EL3 caused by one of the more general types of further trap control (SCR_EL3.EA, HCR_EL2.TEA, HCR_EL2.TGE and HCR_EL2.AMO), but unlike these further trap controls, the TMEA controls are specific to cases when the masking control information is in the masked state (PSTATE.A=0b1) and have no influence on selection of target exception level in a case when the masking control information is in the unmasked state (PSTATE.A=0b0).

Hence, the PSTATE.A flag can be used to protect the syndrome registers from asynchronous exceptions. The flag is set by hardware of the processing circuitry (automatically, without software intervention) when an exception is taken (i.e., the CPU populates the syndrome registers), and can also be set/cleared by software executing an instruction of the instruction set architecture which indicates that the PSTATE.A flag is to be set or cleared. Most of the time, in normal usage, the flag is clear. When the flag is set, the asynchronous exception is masked, that is, not taken. This is an issue for asynchronous error exceptions, because failure to take the error exception promptly could lead to the error propagating. In addition, synchronous exceptions are non-maskable exceptions that are never masked, meaning (unexpected) synchronous error exceptions can overwrite the syndrome registers, which is also an issue for error recovery.

One possible solution to this problem is to direct (route) the error exceptions to a higher exception level, each exception level having its own set of syndrome registers. This is known as firmware-first error handling. A problem with this approach is that it always takes error handling away from the operating system at EL1, and requires complex software constructs to inform the operating system about the error and allow it to recover. It also makes identifying the root cause of errors harder when, as is often the case, the firmware operating at EL2 or EL3 is opaque to the system administrator.

The examples described here introduce a new exception routing control, TMEA (trap-masked-exception control information), which is under control of software at a higher exception level such as EL2 or EL3. When PSTATE.A is clear, error exceptions are taken as normal to the default exception level that would normally handle them without routing to a higher exception level (assuming no trapping to EL2 or EL3 based on one of the other controls SCR_EL3.EA, HCR_EL2.TEA, HCR_EL2.TGE and HCR_EL2.AMO). When PSTATE.A is set and TMEA (at the higher exception level) is set, error exceptions (both synchronous and asynchronous) are taken to the higher exception level that set the TMEA flag. For EL1 in the Arm architecture, there are two higher Exception levels, EL2 and EL3, and as shown above both have TMEA flags that can be set. In the case when both SCR_EL3.TMEA, HCRX_EL2.TMEA are set to the trapped state (0b1) and PSTATE.A is set, the exception is taken to the closest of these higher exception levels (e.g. to EL2 when at EL0 or EL1).

In this way, PSTATE.A can protect the syndrome registers from unexpected error exceptions, but the TMEA control set by the higher exception level provides a “safety net” to ensure that, in the rare cases when PSTATE.A is set to 0b1 to indicate masking, the error does not propagate as the exception can still be taken promptly to the higher exception level. In most cases, though, PSTATE.A will be set to 0b0 and so error exceptions can be handled by the operating system directly at EL1.

In addition, the operating system, or higher exception levels, can also set an NMEA control bit (orthogonally to TMEA), to indicate that asynchronous exceptions should be non-maskable regardless of PSTATE.A. The NMEA control is provided for all exception-handling Exception levels EL1, EL2, EL3. Examples below show how this control interacts with the other controls.

FIG. 4 is a flow diagram illustrating determination of whether a given exception of the maskable class of exceptions (e.g. the asynchronous system error exceptions) should be considered masked so as to prevent them from being taken. At step 100, the exception control circuitry 40 determines whether the current exception level is more privileged than the exception level at which the given exception of the maskable class would, if taken, be taken in the case when the trap-mask-exception control information (i.e. the EL2 and EL3 TMEA controls) is in the untrapped state. Also, at step 102, the exception control circuitry 40 determines whether the masking control information (PSTATE.A) is in the masked state.

If either the current exception level is more privileged than the default exception level which would handle the exception if taken (ignoring any trapping based on TMEA), or the masking control information (PSTATE.A) is in the masked state, then the exception is potentially masked, but it can be overridden based on the non-maskable-exception control information (NMEA controls as mentioned earlier). At step 104, the exception control circuitry 40 determines whether the non-maskable-exception control information (the applicable NMEA control) selected based on the current exception level is set to the non-maskable state (e.g. 0b1). If the non-maskable-exception control information is not in the non-maskable state (i.e. it is in the maskable state, e.g. 0b0), then the determination at steps 100 or 102 that the exception should be masked is not overridden, and at step 106 the exception control circuitry determines whether there is any reason to trap the exception despite being masked (e.g. based on the TMEA controls as discussed in more detail with respect to FIG. 5). If there is no reason to trap the exception, then at step 107 the given exception is determined to be masked, so that the exception is not taken.

If the non-maskable-exception control information is in the non-maskable state (e.g. 0b1), or at step 106 it is determined that there is a reason to trap the exception, then at step 108 the given exception is determined not to be masked, despite the outcome of one of steps 100 and 102 being Y, so that the exception is still taken (as either the NMEA control has overridden the initial determination of masked status, or there was a trap taken based on the TMEA control or another control).

In general, the applicable NMEA control to use at step 104 is selected based on the current exception level, but in some examples other control information may also be relevant. For example, as shown in more detail in FIG. 8E below, the applicable NMEA control is SCR_EL3.NMEA if the current exception level is EL3, SCTLR2_EL2.NMEA if the current exception level is EL2 or the control information indicates that the processing circuitry is currently operating in a host operating system regime, and is SCTLR2_EL1. NMEA if the current exception level is EL1 or EL0 and the processing circuitry is not currently operating in a host operating system regime (see FIG. 8B for an example of how to determine whether the processing circuitry is operating in a host operating system regime, based on the E2H and TGE fields of HCR_EL2 and the current exception level).

If the current exception level is not more privileged than the default exception level at which the given exception would, if taken, be taken in the case when TMEA controls are in the untrapped state (N at step 100), and the masking control information is not in the masked state (PSTATE.A=0b0), then at step 108 the given exception is not masked and the exception is determined to be taken.

FIG. 5 is a flow diagram illustrating steps for determining whether to trap a given exception of the maskable class of exceptions based on the trap-masked-exception control information (TMEA controls). At step 120 the exception control circuitry determines whether the masking control information is in the masked state (e.g., PSTATE.A=0b1). If not, then at step 122, if the given exception has not been determined to be masked according to FIG. 4, then the given exception is taken in a target exception level selected independently of the trap-masked-exception control information.

At step 124, the exception control circuitry determines whether the current exception level is less privileged than the predetermined trap target exception level associated with the trap-masked-exception control information (e.g. in EL0 or EL1, if either the EL2 or EL3 version of the TMEA control is used, or in EL2 if using the EL3 version of the TMEA control). If the current exception level is not less privileged than the exception level EL2 or EL3 associated with a given TMEA control, then that TMEA control is not relevant. If there is no relevant TMEA control applicable for determining handling of exceptions in the current exception level, then at step 122 the given exception is, if not being masked, taken in a target exception level selected independent of the trap-masked-exception control information.

If the masking control information is in the masked state (Y at step 120) and the current exception level is less privileged than the predetermined trap target exception level (EL2 or EL3) associated with at least one item of the trap-masked-exception control information, then at step 126, the exception control circuitry 40 controls whether to trap the given exception to the predetermined trap target exception level depending on whether the trap-masked-exception control information is in the trapped state. If no trap is determined to be required, then at step 128, if the given exception is not being masked, the given exception is taken at a default exception level without trapping based on the trap-masked-exception control information. This default exception level may vary based on other control state (e.g. based on the EA, TEA, AMO, E2H, TGE controls mentioned earlier—see the more detailed examples below for how these can affect the target exception level in the case when there is no trap based on TMEA). If a trap is determined to be required based on the trap-masked-exception control information, then at step 130 the given exception is trapped to the predetermined trap target exception level associated with an item of trap-masked-exception control information that is in the trapped state. If there is more than one relevant item of the trap-masked-exception control information in the trapped state, the trap is taken to the exception level associated with the one of the items of trap-masked-exception control information in the trapped state (TMEA=0b1) for which (while being different to the current exception level) there is a smallest difference in privilege between the current exception level and the associated predetermined trap target exception level. For example, if the current exception level is EL1 and both the EL2 and EL3 TMEA controls are set to 1, the trap would be taken to EL2, while if the current exception level is EL2 then the trap is taken to EL3 even if both EL2 and EL3's TMEA controls are set.

At step 126, the control of whether or not to trap based on the TMEA control can vary depending on which other controls are implemented. In general, the trap is not taken if there is no relevant trap-masked-exception control information (TMEA control) in the trapped state. However, in the case when there is a relevant item of trap-masked-exception control information in the trapped state, whether or not the trap occurs may also depend on other parameters. For example, where the non-maskable-exception control-information (NMEA controls) are supported, in some scenarios the NMEA control being set to the non-maskable state may, in addition to overriding any masking based on PSTATE.A, also override the trap based on the TMEA control. For example, in a scenario when the given exception occurs when the current exception level is a least privileged exception level (EL0), the non-maskable-exception control information is in the non-maskable state (NMEA control=0b1), and the given exception would be taken to a next least privileged exception level that is enabled for taking the given exception in a case when the given exception is not masked and the trap-masked-exception control information is in the untrapped state (e.g. the next least privileged exception level may be EL1 in a guest operating system regime or EL2 in a host operating system regime), the exception control circuitry may determine that the given exception should be taken in the next least privileged exception level, without trapping to the predetermined trap target exception level, even when the trap-masked-exception control information (TMEA) is in the trapped state. Also, another scenario where the trap of step 130 may not occur, despite the relevant TMEA control being set to the trapped state, may be when the EA, AMO, TGE controls mentioned earlier have specified that the exception should be routed to EL3 or EL2 (regardless of the value of the masking information PSTATE or the value of the TMEA control). Hence, in some examples, the decision on whether to trap based on TMEA may be more complex than merely checking the state of the TMEA control itself. The particular decision flow may depend on which other control options are implemented in a particular embodiment.

Nevertheless, in general it is useful to provide the TMEA control to enable users to define that, in at least one scenario where the PSTATE.A flag is set to the masked state, a trap to a more privileged exception level is taken, to allow two competing requirements to be met (that the exception is dealt with promptly and that the syndrome information associated with a less privileged exception level is protected), without unnecessarily requiring every exception to be taken to the higher level in the case when the PSTATE.A flag is in the unmasked state.

FIG. 6 is a flow diagram which illustrates control of whether an update to the trap-masked-exception control information (TMEA control information) is allowed. At step 150, an instruction is executed which requests an update to the trap-masked-exception control information. At step 152, the processing circuitry 4 determines whether the current exception level is less privileged than the predetermined trap target exception level associated with the trap-masked-exception control information being requested to be updated (EL2 for HCRX_EL2.TMEA, EL3 for SCR_EL3.TMEA). If so, then at step 154 the attempt to update the trap-masked-exception control information is either rejected entirely, or trapped to a more privileged exception level so that software at the more privileged exception level can determine whether to allow the requested update. If the current exception level is the predetermined trap target exception level or a more privileged exception level than the predetermined trap target exception level, then at step 156 the requested update to the trap-masked-exception control information is allowed at the current exception level (unless there are any other controls implemented which would cause such a write to the trap-masked-exception control information to be trapped for other reasons). For example, software at EL3 could set a control to trap accesses to HCRX_EL2, causing writes to the EL2 TMEA control from EL2 to be trapped to EL3.

FIG. 7 is a flow diagram illustrating handling of a class of non-maskable exceptions, e.g. the synchronous external abort exceptions. At step 160 a non-maskable exception of this class is detected. At step 162, the exception control circuitry determines whether the control information in registers 14 indicates a scenario where the current exception level is less privileged than the predetermined trap target exception level associated with a given item of trap-masked-exception control information, and the current exception level is capable of being a target exception level for handling exceptions (e.g. EL0 may be incapable of being a target exception level). If not, then at step 164 no trap based on the TMEA control is required, and the exception of the non-maskable class is taken at a target exception level selected based on the current exception level and/or based on other control information (other than the TMEA controls).

If at step 162, it is determined that the current exception level is less privileged than the predetermined trap target exception level associated with a given item of trap-masked-exception control information, and the current exception level is capable of being a target exception level for handling exceptions (and optionally, in some examples, at least one other condition is satisfied, e.g. depending on the SCR_EL3.EA or HCR_EL2.TEA controls which might require a different behaviour to the trap indicated by TMEA), then a trap based on the TMEA control (trap-masked-exception control information) is possible, but depends on other parameters.

At step 166, the exception control circuitry determines whether the masking control information is in the masked state (e.g. PSTATE.A=0b1). If not, then at step 168 no trap based on TMEA is required and the non-maskable exception is taken at a target exception level selected based on the current exception level and/or other control information.

At step 170, the exception control circuitry determines whether the trap-masked-exception control information is in the trapped state (e.g. a relevant TMEA control is set to 0b1).

If the masking control information is in the masked state (Y at step 166) and the trap-masked-exception control information is in the trapped state (Y at step 170), then a trap is taken to the predetermined trap target exception level associated with the TMEA control set to the trapped state (again, if both TMEA controls are set and the current exception level is EL1 then the trap is taken to EL2, the closest level in privilege to the current exception level). The trap based on TMEA is not taken (step 168) if either the masking control information is in the unmasked state (PSTATE=0b0) or the trap-masked-exception control information is in the untrapped state (all TMEA controls are 0b0), although this does not necessarily rule out traps to higher levels for other reasons, such as based on the EA, TEA controls.

Hence, even though the PSTATE.A flag does not cause masking of the non-maskable exception, it can nevertheless be considered for controlling whether the exception is trapped to a more privileged level based on the TMEA control. This is useful because in a case when the PSTATE.A flag is set, there is a preference to preserve syndrome information, so trapping to the higher exception level helps meet this demand even though there would not actually have been any masking. Nevertheless, making this trap conditional on PSTATE.A helps increase the use of kernel-first exception handling and reduces the number of occasions when firmware needs to handle the exception, simplifying software development.

It will be appreciated that, in portions of the flow diagrams where an outcome depends on checking of a number of conditions, those conditions can be checked in any order or in some cases at least partially in parallel, so the specific order of steps shown in the flow diagrams is just one example of how this could be done.

More detailed examples of how the various items of control information described earlier can be used to control exception handling are now described.

FIGS. 8A to 8O illustrate handling of asynchronous system error (SError) exceptions which indicate that an error was detected following a memory system access, where the error is unable to be attributed to a specific point of the instruction stream, so it is unknown which instructions may be affected by the error. This is an example of the maskable class of exceptions described above. These Figures as a whole illustrate a process for determining, based on the current exception level at the time of the exception and the control information shown in FIG. 3, whether the exception should be masked, and if not masked which exception level should take the exception.

FIG. 8A illustrates determination of a value, route_to_el3, which indicates whether the SError exception is to be routed, from a lower exception level, to be taken at EL3. If the current exception level is not EL3 (N at step 1000) and SCR_EL3.EA=0b1 (Y at step 1002), route_to_el3 is TRUE (step 1006), indicating that the exception is to be routed to EL3. If the current exception level is EL3 (Y at step 1000) or SCR_EL3.EA=0b0 (N at step 1002), then route_to_el3 is FALSE (step 1004).

FIG. 8B illustrates determination of a value IsInHost( ) indicating whether processing is currently in a host operating system regime (type 2 hypervisor). IsInHost( ) is FALSE if in a guest operating system regime and is TRUE if in a host operating system regime. If the current exception level it is neither EL2 (N at step 1008) nor EL0 (N at step 1014), IsInHost( ) is FALSE (step 1018). IsInHost( ) is also FALSE (step 1018) if the current exception level is EL2 (Y at step 1008) but HCR_EL2.E2H is 0b0 (N at step 1010) or if the current exception level is EL0 (Y at step 1014) and one or both HCR_EL2.E2H and HCR_EL2.TGE is 0b0 (N at step 1016). IsInHost( ) is TRUE (step 1012) if either the current exception level is EL2 (Y at step 1008) and HCR_EL2.E2H=0b1 (Y at step 1010), or the current exception level is EL0 (Y at step 1014) and both HCR_EL2.E2H and HCR_EL2.TGE are set to 0b1 (Y at step 1016).

FIG. 8C illustrates determination of a value, route_to_el2, which indicates whether the the SError exception is to be routed, from a lower exception level EL0 or EL1, to be taken at EL2. If route_to_el3 is TRUE (N at step 1020), then route_to_el2 is FALSE (step 1032). If route_to_el3 is FALSE (Y at step 1020) and the current exception level is EL2 or EL3 (N at both steps 1022 and 1030), then route_to_el2 is FALSE (step 1032).

If route_to_el3 is FALSE (Y at step 1020), and the current exception level is EL1 (Y at step 1022), then:
at step 1026 route_to_el2 is TRUE if HCR_EL2.AMO is 0b1 (Y at step 1024) and
at step 1028 route_to_el2 is FALSE if HCR_EL2.AMO is 0b0 (N at step 1024).

If route_to_el3 is FALSE (Y at step 1020), the current exception level is EL0 (N at step 1022, Y at step 1030), and either IsInHost( ) as determined in the process of FIG. 8B is TRUE (N at step 1034) or both HCR_EL2.E2H and HCR_EL2.TGE are set to 0b0 (Y at step 1038), route_to_el2 is FALSE (step 1036).

If route_to_el3 is FALSE (Y at step 1020), the current exception level is EL0 (N at step 1022, Y at step 1030), IsInHost( ) is determined in the process of FIG. 8B to be FALSE (Y at step 1034) AND one or both of HCR_EL2.E2H and HCR_EL2.TGE are set to 0b1 (N at step 1038), route_to_el2 is TRUE (step 1040).

FIG. 8D illustrates determination of a value soft_masked representing an initial determination of whether the SError exception should be masked (as mentioned below in FIGS. 8E and 8F, it is possible for this initial determination to be overridden based on the non-maskable exception information (NMEA controls)). The determination of soft_masked depends on the current exception level (step 1042).

If the current exception level is EL3 then soft_masked is TRUE (step 1050) if SCR_EL3.EA=0b0 (Y at step 1044) or PSTATE.A=0b1 (Y at step 1046), and if both SCR_EL3.EA=0b1 (N at step 1044) and PSTATE.A=0b0 (N at step 1046) then soft_masked is FALSE (step 1048).

If the current exception level is EL2, then:
soft_masked is FALSE (step 1054) if route_to_el3 as determined in FIG. 8A is TRUE (N at step 1052).
If route_to_el3 is FALSE (Y at step 1052), then:
   soft_masked is TRUE (step 1060) if HCR_EL2.TGE and HCR_EL2.AMO are both 0 (Y at step 1056) or if PSTATE.A=1 (Y at step 1058).
   soft_masked is FALSE (step 1062) if one or both of HCR_EL2.TGE and HCR_EL2.AMO is 0b1 (N at step 1056) and PSTATE.A=0 (N at step 1058).

If the current exception level is EL0 or EL1, then:
soft_masked is FALSE (step 1070) if route_to_el3 as determined in FIG. 8A is TRUE (N at step 1064) or route_to_el2 as determined in FIG. 8C is TRUE (N at step 1066).
if both route_to_el3 and route_to_el2 are FALSE, then soft_masked is TRUE (step 1072) if PSTATE.A=1 (Y at step 1068) and is FALSE (step 1070) if PSTATE.A=0 (N at step 1068).
   Note that, since steps 1044, 1056 are passed if the EA, TGE, AMO controls have not been set to trap SError exceptions to one of the higher levels, the effect of steps 1044, 1056 is that SError exceptions can be considered masked at steps 1050 or 1060 in the case that the current exception level (EL3 in the case of step 1050, or EL2 in the case of step 1060) is more privileged than the exception level designated for taking the exception level (ignoring the TMEA trap controls).

FIG. 8E illustrates selection of which of the respective items of non-maskable-exception control information (NMEA controls) to use to determine whether the masked status determined in FIG. 8D should be overridden. This depends on the current exception level and the IsInHost( ) status as determined in FIG. 8B. If the current exception level is EL3 (Y at step 1076), then the NMEA control to use is SCR_EL3.NMEA (step 1078). If the current exception level is EL2 (Y at step 1080) or IsInHost( ) is TRUE (Y at step 1084), then the NMEA control to use is SCTLR2_EL2.NMEA (step 1082). If the current exception level is EL1 or EL0 (N at step 1080) and IsInHost( ) is FALSE (N at step 1084), then the NMEA control that is selected is SCTLR2_EL1.NMEA (step 1086).

FIG. 8F illustrates application of the selected NMEA control to determine whether the initial masked determination of FIG. 8D should be overridden to prevent masking of the SError exception. If soft_masked was already determined to be FALSE in the process of FIG. 8D (N at step 1098), then it will remain FALSE regardless of the value of the selected NMEA control (step 1100). If soft_masked was TRUE (Y at step 1098) and the selected NMEA control is in the non-maskable state 0b1 (N at step 1102), then soft_masked becomes FALSE (step 1100) so that the previous masked status has been overridden based on the non-maskable indication provided by the NMEA control. If soft_masked was TRUE (Y at step 1098) and the selected NMEA control is in the maskable state 0b0 (Y at step 1102), then soft_masked remains TRUE (step 1104) and so the SError exception will be masked to prevent it from being taken (yet—the exception remains pending and so could still be taken later if the PSTATE.A flag is later cleared to the unmasked state 0b0).

FIG. 8G illustrates determination of a signal route_soft_masked_to_el2 indicating whether a trap to EL2 should be taken based on the EL2 version of the TMEA control, HCRX_EL2.TMEA. This is the trap taken when PSTATE.A=1 to ensure the SError exception can be handled more promptly at EL2 while preserving the exception syndrome information in the EL1 set of syndrome registers.

At step 1122, the parameter route_soft_masked_to_el2 is determined to be FALSE (i.e. the trap based on TMEA does not occur), if either route_to_el3 determined in FIG. 8A is TRUE (N at step 1108) or an external debugger has disabled exceptions from being taken at exception levels below EL3 (Y at step 1110). Assuming neither of these conditions is satisfied (Y at step 1108 and N at step 1110), then:
if HCRX_EL2.TMEA is in the untrapped state (0b0—N at step 1112), then route_soft_masked_to_el2 is FALSE (step 1122), since in this case the EL2 software has not set the trap-masked-exception control information to indicate that a trap to EL2 dependent on PSTATE.A is desired.
if HCRX_EL2.TMEA is in the trapped state (0b1—Y at step 1112) then a trap to EL2 due to TMEA is possible, but whether it occurs also depends on other parameters:
   if the current exception level is EL1 (Y at step 1114) and PSTATE.A is in the masked state (0b1—Y at step 1116), then route_soft_masked_to_el2 is TRUE (step 1118).
   If the current exception level is EL1 (Y at step 1114) but PSTATE.A is in the unmasked state (0b0—N at step 1116), then route_soft_masked_to_el2 is FALSE (step 1120).
   If the current exception level is EL0 (Y at step 1124), the masked status (following any NMEA override being evaluated) is TRUE (Y at step 1126) and IsInHost( ) determined in FIG. 8B is FALSE (Y at step 1128), then route_soft_masked_to_el2 is TRUE (step 1130). Note that at step 1126 the term “soft_masked” refers to the final masked status determined based on NMEA in the process of FIG. 8F, not the initial masked status (prior to any NMEA override) determined in FIG. 8D.
   If the current exception level is EL0 (Y at step 1124), the masked status as determined following the NMEA override in the process of FIG. 8F (not the initial masked status determined in FIG. 8D) is FALSE (N at step 1126) or IsInHost( ) determined in FIG. 8B is TRUE (N at step 1128), then route_soft_masked_to_el2 is FALSE (step 1122).
   If the current exception level is EL2 or EL3 (N at step 1124), then route_soft_masked_to_el2 is FALSE (step 1122).

FIG. 8H illustrates determination of a signal route_soft_masked_to_el3 indicating whether a trap to EL3 should be taken based on the EL3 version of the TMEA control, SCR_EL3.TMEA. Again, if taken, this trap is intended to allow the SError exception to be handled more promptly at EL3 while still enabling preservation the exception syndrome information in the EL1 or EL2 set of syndrome registers given that PSTATE.A=1.

If handling of the exception at EL3 is disabled by an external debugger (Y at step 1136), then route_soft_masked_to_el3 is FALSE (step 1134).

If SCR_EL3.TMEA is in the untrapped state (0b0—N at step 1138), then route_soft_masked_to_el3 is FALSE (step 1134), since in this case EL3 software has not expressed any preference to avoid masking SError exceptions at lower levels when PSTATE.A=1.

If there is no disabling of exceptions at EL3 by an external debugger (N at step 1136) and SCR_EL3.TMEA is in the trapped state (0b1—Y at step 1138), then a trap to EL3 due to TMEA is possible, but whether it occurs also depends on other parameters:
If either route_to_el2 OR route_soft_masked_to_el2 is TRUE (N at step 1140 or step 1142), then:
   route_soft_masked_to_el3 is TRUE (step 1154) if the current exception level is less privileged than EL3 (N at step 1150) and taking of exceptions at less privileged levels than EL3 is currently disabled by an external debugger (Y at step 1152); and
   route_soft_masked_to_el3 is FALSE (step 1156) if the current exception level is EL3 (Y at step 1150) or taking of exceptions at less privileged levels than EL3 is not currently disabled by an external debugger (N at step 1152).
Therefore, in the absence of an external debugger disabling exceptions from being taken at EL0-EL2, the TMEA trap to EL2 as determined in FIG. 8G will take precedence over a TMEA trap to EL3—due to step 1142 if both SCR_EL3.TMEA and HCRX_EL2.TMEA are set to the trapped state, the trap will be taken to EL2, the closest exception level (least difference in privilege) to the EL1/EL0 levels at which the SError can occur when the HCRX_EL2.TMEA is relevant.
If route_to_el2 AND route_soft_masked_to_el2 are both FALSE (Y at steps 1140 and 1142), then route_soft_masked_to_el3 is TRUE (step 1146) if either:
   the current exception level is EL2 or EL1 and PSTATE.A is in the masked state (0b1—Y at step 1144), or
   the current exception level is EL2 or EL0 and the masked status is TRUE (Y at step 1148). Again, soft_masked in step 1148 refers to the masked status following the NMEA override in the process of FIG. 8F (not the initial masked status determined in FIG. 8D).
route_soft_masked_to_el3 can also be TRUE (step 1154) if route_to_el2 and route_soft_masked_to_el2 are both FALSE (Y at steps 1140 and 1142), neither of the conditions tested at steps 1144, 1148 is satisfied, the current exception level is less privileged than EL3 (N at step 1150) and taking of exceptions at less privileged levels than EL3 is currently disabled by an external debugger (Y at step 1152).

Note the difference between steps 1116 and 1126 of FIG. 8G and between steps 1144 and 1148 of FIG. 8H. For exceptions occurring when the current exception level is EL1, the TMEA trap depends on PSTATE.A being 1, regardless of whether the actual masking status determined in FIG. 8F has been overridden using the NMEA control. This is because in EL1, the setting of PSTATE.A to the masked state (0b1) indicates that the current state of processing at EL1 is such that there is some important syndrome information to protect in the EL1 syndrome registers, so even though the masking has been overridden using the NMEA control, it is still desirable to perform the TMEA trap to EL2 or EL3 to protect the syndrome information in the EL1 syndrome registers. In contrast, for exception level EL0, the TMEA trap depends on the actual masking status determined in FIG. 8F (after being overridden using the NMEA control). Hence, the NMEA control being set to 1 would prevent the TMEA trap being taken from EL0 to EL2 or EL3, and instead the non-masked exception would be taken to its default exception level (e.g. EL1) unless another control takes precedence (e.g. the EA, AMO, TGE controls). This behaviour for EL0 is useful because in the EL0 exception level (which is incapable of being a target exception level for handling an exception) there is no exception syndrome information to protect, so there is no need to trap to EL2 or EL3 even if the relevant TMEA control is set, as it can be assumed that any EL1 syndrome information is no longer required as there has already been a previous exception return to EL0 since that EL1 syndrome information was captured. Therefore, there is no need to trap to EL2 or EL3 to protect EL1's syndrome information in the case when the NMEA control has prevented the masking occurring, even if the relevant TMEA control is set to the trapped state (0b1).

FIG. 8I shows determination of a “routed_away” indication indicating whether there is any reason to route the SError exception away from the default exception level (e.g. EL1 in a guest operating system environment, or EL2 in a host operating system environment) that would otherwise take the exception. The routed_away indication is TRUE (step 1160) if any of route_to_el2, route_soft_masked_to_el2, route_to_el3 or route_soft_masked_to_el3 is TRUE as determined in the processes shown in FIGS. 8C, 8G, 8A and 8H respectively (Y at steps 1158, 1162, 1164, 1166). If route_to_el2, route_soft_masked_to_el2, route_to_el3 and route_soft_masked_to_el3 are all FALSE (N at step 1166) then routed_away is FALSE (step 1168).

FIG. 8J illustrates determination of a final masked status, indicating whether the exception is actually masked (prevented from being taken). If soft_masked, as determined following any NMEA override in FIG. 8F, is TRUE (Y at step 1170) and routed_away as determined in FIG. 8I is FALSE (Y at step 1174), then masked is TRUE (step 1176), indicating that the exception will be prevented from being taken. If either soft_masked (following any NMEA override) is FALSE (N at step 1170) or routed_away is TRUE (N at step 1174) then masked is FALSE (step 1172) as the exception will be taken.

FIG. 8K illustrates determination of whether the exception should be taken at EL3. If the current exception level is EL3 (Y step 1178) and the exception is not masked (Y at step 1180), then take_in_el3 is TRUE (step 1184), and otherwise take_in_el3 is FALSE (step 1182).

FIG. 8L illustrates determination of whether the exception should be taken at EL2 (take_in_el2_0). If the current exception level is EL2 (Y at step 1186) or IsInHost( ) determined as in FIG. 8B is TRUE (Y at step 1188), routed_away as determined in FIG. 8I is FALSE (Y at step 1192) and the exception is determined not to be masked as in FIG. 8J (Y at step 1194), then take_in_el2_0 is TRUE (step 1196). Otherwise, take_in_el2_0 is FALSE (step 1190).

FIG. 8M illustrates determination of whether the exception should be taken at EL1 (take_in_el1_0). If the current exception level is EL1 (Y at step 1198) or the current exception level is EL0 and IsInHost( ) is FALSE (Y at step 1200), routed_away is FALSE (Y at step 1204) and the exception is determined not to be masked (Y at step 1206), then take_in_el1_0 is TRUE (step 1208). Otherwise, take_in_el1_0 is FALSE (step 1202).

FIG. 8N illustrates selection of the target exception level for taking the exception. If the exception is determined according to FIG. 8J to be masked (N at step 1210) then the target exception level is unknown as the exception will not be taken.

If the “masked” status is FALSE (Y at step 1210) and any of take_in_el3 (FIG. 8K), route_to_el3 (FIG. 8A) and route_soft_masked_to_el3 (FIG. 8H) is TRUE (Y at step 1214), then the target exception level is EL3 (step 1216).

If masked is FALSE (Y at step 1210), the exception is not being taken in EL3 (N at step 1214) and any of take_in_el2_0 (FIG. 8L), route_to_el2 (FIG. 8C) and route_soft_masked_to_el2 (FIG. 8G) is TRUE (Y at step 1218), then the target exception level is EL2 (step 1220).

If masked is FALSE (Y at step 1210), the exception is not being taken at EL3 or EL2 (N at steps 1214 and 1218), then the target exception level is EL1 (step 1224). Note that in some cases there could be an additional check of whether “take_in_el1_0” (determined according to FIG. 8M) is TRUE, before determining that the target exception level is EL1. In practice, however, the state when the outcomes of steps 1210, 1214, 1218 are all N and “take_in_el1_0” is FALSE should be unreachable, as noted in the pseudocode below, so the check of whether “take_in_el1_0” is TRUE may be redundant.

FIG. 8O illustrates a further ability to mask exceptions based on an external debugger disabling exceptions at the target exception level determined in FIG. 8N. If the external debugger has disabled exceptions at the target exception level (Y at step 1228), masked becomes TRUE and the target exception level becomes unknown (step 1232). Otherwise, the masked status and target exception level remain as determined according to FIGS. 8J and 8N respectively.

FIGS. 9A to 9I illustrate handling of synchronous external abort exceptions which indicate that an external memory system error was detected following a memory system access (other than MMU faults), where the error is able to be attributed to a specific point of the instruction stream being executed. This is an example of the non-maskable class of exceptions described above. These Figures as a whole illustrate a process for determining which exception level should take the exception, based on the current exception level at the time of the exception and the control information shown in FIG. 3. This type of exception cannot be masked. For references to “IsinHost( )” in FIGS. 9A to 9I, this is determined in the same way as shown in FIG. 8B for asynchronous SError exceptions, so this is not repeated again here.

FIG. 9A illustrates determination of a value, route_to_el3, which indicates whether the synchronous external abort exception is to be routed, from a lower exception level, to be taken at EL3. If the current exception level is not EL3 (N at step 1234) and SCR_EL3.EA=0b1 (Y at step 1236), then route_to_el3 is TRUE (step 1240), indicating that the exception is to be routed to EL3. If the current exception level is EL3 (Y at step 1234) or SCR_EL3.EA=0b0 (N at step 1236), then route_to_el3 is FALSE (step 1238).

FIG. 9B illustrates determination of a value, route_to_el2, which indicates whether the the synchronous external abort is to be routed, from a lower exception level, to be taken at EL2. References to “tea_bit” refer to the value of the HCR_EL2.TEA control (step 1254). If route_to_el3 as determined in FIG. 9A is TRUE (N at step 1256), then route_to_el2 is FALSE (step 1258).

If route_to_el3 is FALSE (Y at step 1256) and the current exception level is EL1 (Y at step 1260), then:
if either the tea_bit is 1 or the fault is of a specific type to be handled at EL2 (Y at step 1262), then route_to_el2 is TRUE (step 1264). For example, the specific type of fault to be handled at EL2 could include a fault related to an access to a system register managed by software executing at EL2 which is being emulated through access to memory, or could be a second-stage address translation fault detected by the MMU in a two-stage address translation regime where address translation is controlled based on first-stage page tables defined by an operating system to map virtual addresses to intermediate addresses and second-stage page tables defined by a hypervisor to map intermediate addresses to physical addresses.
If tea_bit is 0 and the fault is not of the type to be handled at EL2 (N at step 1262), then route_to_el2 is FALSE (step 1266).

If route_to_el3 is FALSE (Y at step 1256), and the current exception level is EL0 (Y at step 1268), then:
route_to_el2 is TRUE (step 1276) if IsInHost( ) (determined according to FIG. 8B) is FALSE (Y at step 1270) and either the tea_bit is 1, the HCR_EL2.TGE control is 1, or the fault is of one of the types to be handled at EL2 (Y at step 1274).
route_to_el2 is FALSE (step 1272) if either IsInHost( ) is TRUE (N at step 1270) or all of the following are satisfied: tea_bit=0b0, HCR_EL2.TGE=0b0 and the fault is not of the types to be handled at EL2 (N at step 1274).

If the current exception level is EL3 or EL2 then route_to_el2 is FALSE (step 1278, following N at step 1268).

FIG. 9C illustrates determination of a signal route_soft_masked_to_el2 indicating whether a trap to EL2 should be taken based on the EL2 version of the TMEA control, HCRX_EL2.TMEA. This is the trap taken when PSTATE.A=1 to ensure the synchronous external abort exception can be handled more promptly at EL2 while enabling preservation the exception syndrome information in the EL1 set of syndrome registers.

The parameter route_soft_masked_to_el2 is determined to be FALSE (step 1282) if any one or more of the following applies:
route_to_el3 (as determined according to FIG. 9A) is TRUE (N at step 1280);
the current exception level is any exception level other than EL1 (N at step 1284);
PSTATE.A=0 (N at step 1286);
HCRX_EL2.TMEA=0 (N at step 1288).

The parameter route_soft_masked_to_el2 is determined to be TRUE (step 1282) if all of the following conditions are satisfied:
route_to_el3 is FALSE (Y at step 1280);
the current exception level is EL1 (Y at step 1284);
PSTATE.A=1 (Y at step 1286);
HCRX_EL2.TMEA=1 (Y at step 1288).
   Hence, HCRX_EL2.TMEA being set to 1 (the trapped state) causes synchronous external abort exceptions to trap to EL2 if they occur at EL1 when PSTATE.A is set to the masked state. This trap is not taken if PSTATE.A is 0 (the unmasked state).

FIG. 9D illustrates determination of a signal route_soft_masked_to_el3 indicating whether a trap to EL3 should be taken based on the EL3 version of the TMEA control, SCR_EL3.TMEA.

The parameter route_soft_masked_to_el3 is determined to be FALSE (step 1294) if any one or more of the following applies:
route_to_el2 (as determined according to FIG. 9B) is TRUE (N at step 1292);
route_soft_masked_to_el2 (as determined according to FIG. 9C) is TRUE (N at step 1296);
the current exception level is any exception level other than EL1 or EL2 (N at step 1298).
PSTATE.A=0 (N at step 1300).
SCR_EL3.TMEA=0 (N at step 1302).

The parameter route_soft_masked_to_el3 is determined to be TRUE (step 1304) if all of the following conditions are satisfied:
route_to_el2 is FALSE (Y at step 1292);
route_soft_masked_to_el2 is FALSE (N at step 1296);
the current exception level is EL1 or EL2 (Y at step 1298);
PSTATE.A=1 (Y at step 1300);
SCR_EL3.TMEA=1 (Y at step 1302).
   Hence, SCR_EL3.TMEA being set to 1 (the trapped state) causes synchronous external abort exceptions to trap to EL3 if they are not being trapped to EL2 based on HCRX_EL2.TMEA or HCR_EL2.TEA and occur at EL1 or EL2 when PSTATE.A is set to 1 (the masked state). This trap is not taken if PSTATE.A is 0 (the unmasked state).

FIG. 9E shows determination of a “routed_away” indication indicating whether there is any reason to route the synchronous external abort exception away from the default exception level (e.g. EL1 or EL2) that would otherwise take the exception. The routed_away indication is TRUE (step 1308) if any of route_to_el2, route_soft_masked_to_el2, route_to_el3 or route_soft_masked_to_el3 is TRUE as determined in the processes shown in FIGS. 9B, 9C, 9A and 9D respectively (Y at steps 1306, 1310, 1312, 1314). If route_to_el2, route_soft_masked_to_el2, route_to_el3 and route_soft_masked_to_el3 are all FALSE (N at steps 1306, 1310, 1312, 1314) then routed_away is FALSE (step 1316).

FIG. 9F illustrates determination of whether the exception should be taken at EL3 (take_in_el3). If the current exception level is EL3 (Y step 1318), then take_in_el3 is TRUE (step 1322), and otherwise take_in_el3 is FALSE (step 1320).

FIG. 9G illustrates determination of whether the exception should be taken at EL2 (take_in_el2_0). If the current exception level is EL2 (Y at step 1324) or IsInHost( ) determined as in FIG. 8B is TRUE (Y at step 1326), and routed_away as determined in FIG. 9E is FALSE (Y at step 1330), then take_in_el2_0 is TRUE (step 1332). Otherwise, take_in_el2_0 is FALSE (step 1328).

FIG. 9H illustrates determination of whether the exception should be taken at EL1 (take_in_el1_0). If the current exception level is EL1 (Y at step 1334) or the current exception level is EL0 and IsInHost( ) is FALSE (Y at step 1336) and routed_away is FALSE (Y at step 1340), then take_in_el1_0 is TRUE (step 1342). Otherwise, take_in_el1_0 is FALSE (step 1338).

FIG. 9I illustrates selection of the target exception level for taking the exception. If any of take_in_el3 (FIG. 9F), route_to_el3 (FIG. 9A) and route_soft_masked_to_el3 (FIG. 9D) is TRUE (Y at step 1344), then the target exception level is EL3 (step 1346).

If the exception is not being taken in EL3 (N at step 1344) and any of take_in_el2_0 (FIG. 9G), route_to_el2 (FIG. 9B) and route_soft_masked_to_el2 (FIG. 9C) is TRUE (Y at step 1348), then the target exception level is EL2 (step 1350).

If the exception is not being taken in EL3 or EL2 (N at step 1348), then the target exception level is EL1 (step 1354). Note that in some cases there could be an additional check of whether “take_in_el1_0” (determined according to FIG. 9H) is TRUE, before determining that the target exception level is EL1. In practice, however, the state when the outcomes of steps 1344 and 1348 being N and “take_in_el1_0” is FALSE should be unreachable, as noted in the pseudocode below, so the check of whether “take_in_el1_0” is TRUE may be redundant.

For the flow diagrams shown above, it will be appreciated that the same logical functions could be achieved by performing steps in a different order, or performing some steps in parallel. Also, not all the steps are essential for a given embodiment. In some implementations, certain types of exception routing control may not be supported, as shown in the pseudocode below where there are some additional tests for whether certain optional features are supported (e.g. see the tests of variables of the form “???Enabled( )” or “Have???( )”, which are variables indicating whether certain optional features are enabled and implemented). The AND or Boolean relations shown in the pseudocode show what would happen if one of these optional features was not supported. In most cases, if an exception routing control is not supported, the corresponding control value is treated as if it is 0b0.

Example pseudocode for implementing the functions of FIGS. 8A to 8O is shown below:

```
// Returns a tuple of whether SError exception can be taken and, if
// so, the target Exception level
(boolean, bits(2)) AArch64.PhysicalSErrorTarget( )
boolean route_to_el3;
boolean route_to_el2;
// The exception is explicitly routed to EL3
if PSTATE.EL != EL3 then
  route_to_el3 = (HaveEL(EL3) && SCR_EL3.EA == ‘1’);
else
  route_to_el3 = FALSE;
// The exception is explicitly routed to EL2
if !route_to_el3 && EL2Enabled( ) && PSTATE.EL == EL1 then
  route_to_el2 = (HCR_EL2.AMO == ‘1’);
elsif !route_to_el3 && EL2Enabled( ) && PSTATE.EL == EL0 then
  route_to_el2 = (!IsInHost( ) && HCR_EL2.<TGE,AMO> != ‘00’);
else
  route_to_el2 = FALSE;
// The exception is “masked” by software or hardware
boolean soft_masked;
case PSTATE.EL of
  when EL3
      soft_masked = (SCR_EL3.EA == ‘0’ || PSTATE.A == ‘1’);
  when EL2
      soft_masked = (!route_to_el3 &&
                  (HCR_EL2.<TGE,AMO> == ‘00’ ||
                      PSTATE.A == ‘1’));
  when EL1, EL0
      soft_masked = (!route_to_el3 && !route_to_el2
                        && PSTATE.A == ‘1’);
// The exception is “disabled” by external debug in the current
Security state
boolean intdis = ExternalDebugInterruptDisabled(EL1);
// When FEAT_DoubleFault or FEAT_DoubleFault2 is implemented,
// the mask might be overridden
if HaveDoubleFault2Ext( ) then
  bit nmea_bit;
  if PSTATE.EL == EL3 then
      nmea_bit = SCR_EL3.NMEA;
  elsif PSTATE.EL == EL2 || IsInHost( ) then
      nmea_bit = if IsSCTLR2EL2Enabled( ) then SCTLR2_EL2.NMEA
              else ‘0’;
  else
      nmea_bit = if IsSCTLR2EL1Enabled( ) then SCTLR1_EL2.NMEA
              else ‘0’;
  soft_masked = soft_masked && (nmea_bit == ‘0’);
elsif HaveDoubleFaultExt( ) && PSTATE.EL == EL3 then
    bit nmea_bit = SCR_EL3.NMEA AND SCR_EL3.EA;
    soft_masked = soft_masked && (nmea_bit == ‘0’);
boolean route_soft_masked_to_el3;
boolean route_soft_masked_to_el2;
if HaveDoubleFault2Ext( ) then
  // The soft_masked exception is routed to EL2
  route_soft_masked_to_el2 =
              (EL2Enabled( ) && !route_to_el3 && !intdis &&
              ((PSTATE.EL == EL1 && PSTATE.A == ‘1’) ||
              (PSTATE.EL == EL0 && soft_masked && !IsInHost( )))
                  && (IsHCRXEL2Enabled( ) && HCRX_EL2.TMEA == ‘1’));
  // The soft_masked exception is routed to EL3
  route_soft_masked_to_el3 =
        (HaveEL(EL3) && !ExternalDebugInterruptDisabled(EL3) &&
                ((!(route_to_el2 || route_soft_masked_to_el2) &&
                  ((PSTATE.EL IN {EL2, EL1} && PSTATE.A == ‘1’) ||
                    (PSTATE.EL IN {EL2, EL0} && soft_masked))) ||
                    (PSTATE.EL != EL3 && intdis)) &&
                    SCR_EL3.TMEA == ‘1’);
else
  route_soft_masked_to_el2 = FALSE;
  route_soft_masked_to_el3 = FALSE;
// The exception is routed away from the current exception regime
routed_away = (route_to_el2 || route_soft_masked_to_el2 ||
        route_to_el3 || route_soft_masked_to_el3);
// The exception is actually “masked” - “disabled” will be factored in
// later
masked = soft_masked && !routed_away;
// The exception is taken at EL3
take_in_el3 = PSTATE.EL == EL3 && !masked;
// The exception is taken at EL2 or from the Host EL0 to EL2
take_in_el2_0 = ((PSTATE.EL == EL2 || IsInHost( )) &&
                !routed_away && !masked);
// The exception is taken at EL1 or from the non-Host EL0 to EL1
take_in_el1_0 = ((PSTATE.EL == EL1 ||
            (PSTATE.EL == EL0 && !IsInHost( ))) &&
          !routed_away && !masked);
bits(2) target_el;
if masked then
  target_el = bits(2) UNKNOWN;
elsif take_in_el3 || route_to_el3 || route_soft_masked_to_el3_then
  target_el = EL3;
elsif take_in_el2_0 || route_to_el2 || route_soft_masked_to_el2 then
  target_el = EL2;
elsif take_in_el1_0 then
  target_el = EL1;
else
  Unreachable( );
// The exception is “disabled” by external debug for the actual target
if ExternalDebugInterruptDisabled(target_el) then
  masked = TRUE;
  target_el = bits(2) UNKNOWN;
return (masked, target_el);
```

Example pseudocode for the function IsInHost( ) is as follows:

```
// IsInHost( )
// ==========
boolean IsInHost(bits(2) el)
  if !HaveVirtHostExt( ) || ELUsingAArch32(EL2) then
    return FALSE;
  case PSTATE.EL of
    when EL3
      return FALSE;
    when EL2
      return EL2Enabled( ) && HCR_EL2.E2H == ‘1’;
    when EL1
      return FALSE;
    when EL0
      return EL2Enabled( ) && HCR_EL2.<E2H,TGE> == ‘11’;
    otherwise
      Unreachable( );
```

FIGS. 10A and 10B show a summary table indicating, for each combination of values of the control information, whether the asynchronous system error (SError) exception occurring in any of the exception levels EL0, EL1, EL2, EL3 would be taken or masked, and if taken which exception level would be the target exception level in which the exception is taken.

Each column in the left-hand side of the table refers to a bit in one of the system registers for the labelled exception level, or to the PSTATE.A flag (with “x” indicating that it does not matter whether the corresponding control is 0b0 or 0b1), as follows:
EA EL3 means SCR_EL3.EA
TMEA EL3 means SCR_EL3.TMEA
NMEA EL3 means SCR_EL3.NMEA
TGE EL2 means HCR_EL2.TGE
E2H EL2 means HCR_EL2.E2H
AMO EL2 means HCR_EL2.AMO
NMEA EL2 means SCTLR2_EL2.NMEA
TMEA EL2 means HCRX_EL2.TMEA
NMEA EL1 means SCTLR2_EL1.NMEA
A PSTATE means PSTATE.A.

Each column in the right-hand side of the table shows the outcome if the SError exception occurs for the corresponding set of control information values, when the current exception level is EL3, EL2, EL1, EL0 respectively. Each cell in the right-hand columns represents one of the following outcomes:
ELx means the error exception is taken to ELx.
B means the error exception is not taken because it is masked by PSTATE.A, and remains pending.
C means the error exception is not taken because it is implicitly masked (due to the current exception level being more privileged than the exception level which should take the exception), and remains pending.
n/a: means the exception level is not accessible in this configuration.

These values are determined according to the pseudocode above and the functions shown in FIGS. 8A to 8O.

Any of the control options other than TMEA and PSTATE.A are optional and if omitted can be treated in the same way as if they were set to 0b0.

Example lines to note in FIGS. 10A and 10B include:
line 1: error exceptions at EL1 and EL0 are taken to the default exception level EL1, and at EL2 and EL3 are implicitly masked because of being in a more privileged exception level than the default exception level EL1. No trap controls have been set.
line 2: setting PSTATE.A to 1 causes the error exception to be masked at EL1 and EL0.
line 3: setting NMEA EL1 to 1 prevents masking of the error exception even if PSTATE.A is 1.
lines 4 and 5: setting TMEA EL2 to 1 causes the error exception to be trapped to EL2 from EL1 or EL0 if PSTATE.A is 1, but if PSTATE.A is 0 the behaviour is still as in line 1.
line 6: if TMEA EL2 and NMEA EL1 are both 1 and PSTATE.A is 1, the non-maskable status caused by NMEA=1 overrides the trap to EL2 if the error exception occurs at EL0, but not if the error exception occurs at EL1, so that when TMEA EL2, NMEA EL1 and PSTATE.A are all 1 but none of the other trap controls are set, error exceptions occurring at EL0 are taken at EL1 but error exceptions occurring at EL1 are taken at EL2.
line 7: setting NMEA EL2 to 1 means that the error exception is taken to EL2 even if occurring at EL2, rather than being implicitly masked as in lines 1-6.
lines 13-19 and 63-68: the TMEA controls have no influence when any of the EA EL3, TGE EL2 and AMO EL2 controls are set, as in these cases there is explicit routing of error exceptions to EL2 or EL3.
line 41: if both TMEA EL3 and TMEA EL2 are set and PSTATE.A is set, the TMEA-based trap from EL0 and EL1 is taken to EL2, i.e. the TMEA-associated exception level that is closest in privilege to the current exception level, and the TMEA-based trap from EL2 is taken to EL3. Line 42 shows how if NMEA EL1 is 1 then this overrides the TMEA-based trap from EL0 so that instead the exception is taken at EL1 (similar to line 6).

Example pseudocode for implementing the functions of FIGS. 9A to 9I is shown below:

```
// AArch64.SyncExternalAbortTarget( )
// =================================
// Returns the target Exception level for a Synchronous External Data
// or Instruction Abort
bits(2) AArch64.SyncExternalAbortTarget(FaultRecord fault)
    boolean route_to_el3;
    boolean route_to_el2;
    // The exception is explicitly routed to EL3
    if PSTATE.EL != EL3 then
        route_to_el3 = (HaveEL(EL3) && SCR_EL3.EA == ‘1’);
    else
        route_to_el3 = FALSE;
    // The exception is explicitly routed to EL2
    bit tea_bit = (if HaveRASExt( ) then HCR_EL2.TEA else ‘0’);
    if !route_to_el3 && EL2Enabled( ) && PSTATE.EL == EL1 then
        route_to_el2 = (tea_bit == ‘1’ ||
                  fault.acctype == AccType_NV2REGISTER ||
                  IsSecondStage(fault));
    elsif !route_to_el3 && EL2Enabled( ) && PSTATE.EL == EL0 then
        route_to_el2 = (!IsInHost( ) && (HCR_EL2.TGE == ‘1’ ||
            tea_bit == ‘1’ || IsSecondStage(fault)));
    else
        route_to_el2 = FALSE;
    boolean route_soft_masked_to_el3;
    boolean route_soft_masked_to_el2;
    if HaveDoubleFault2Ext( ) then
        // The soft masked exception is routed to EL2
        route_soft_masked_to_el2 = (EL2Enabled( ) && !route_to_el3 &&
                    (PSTATE.EL == EL1 && PSTATE.A == ‘1’)
                && (IsHCRXEL2Enabled( ) && HCRX_EL2.TMEA == ‘1’));
        // The soft_masked exception is routed to EL3
        route_soft_masked_to_el3 =
                      (HaveEL(EL3) &&
                !(route_to_el2 || route_soft_masked_to_el2) &&
                (PSTATE.EL IN {EL2, EL1} && PSTATE.A == ‘1’) &&
                      SCR_EL3.TMEA == ‘1’);
    else
        route_soft_masked_to_el2 = FALSE;
        route_soft_masked_to_el3 = FALSE;
    // The exception is routed away from the current exception regime
    routed_away = (route_to_el2 || route_soft_masked_to_el2 ||
              route_to_el3 || route_soft_masked_to_el3);
    // The exception is taken at EL3
    take_in_el3 = PSTATE.EL == EL3;
    // The exception is taken at EL2 or in the Host EL0
  take_in_el2_0 = ((PSTATE.EL == EL2 || IsInHost( )) && !routed_away);
    // The exception is taken at EL1 or in the non-Host EL0
  take_in_el1_0 = ((PSTATE.EL == EL1 ||
                (PSTATE.EL == EL0 && !IsInHost( )))
                && !routed_away);
    bits(2) target_el;
    if take_in_el3 || route_to_el3 || route_soft_masked_to_el3 then
        target_el = EL3;
    elsif take_in_el2_0 || route_to_el2 || route_soft_masked_to_el2
      then
          target_el = EL2;
    elsif take_in_el1_0 then
        target_el = EL1;
    else
        Unreachable( );
    return target_el;
```

FIG. 11 shows a summary table indicating, for each combination of values of the control information, which exception level is the target exception level for a (non-maskable) synchronous external abort exception occurring in any of the exception levels EL0, EL1, EL2, EL3. The column TEA EL2 refers to the value of HCR_EL2.TEA, and the other columns have the same meanings as in FIGS. 10A and 10B. Note lines 2 and 3 which show that when TMEA EL2 is 1, a trap to EL2 is taken from EL1 (but not EL0) when PSTATE.A is 1, but when PSTATE.A is 0 then the exception is taken at EL1 from both EL1 and EL0.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

FIG. 12 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 330, optionally running a host operating system 320, supporting the simulator program 310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 330), some simulated embodiments may make use of the host hardware, where suitable.

The simulator program 310 may be stored on a computer-readable storage medium (which may be a non-transitory medium), and provides a program interface (instruction execution environment) to the target code 300 (which may include applications, operating systems and a hypervisor) which is the same as the application program interface of the hardware architecture being modelled by the simulator program 310. Thus, the program instructions of the target code 300 may be executed from within the instruction execution environment using the simulator program 310, so that a host computer 330 which does not actually have the hardware features of the apparatus 2 discussed above can emulate these features. Hence, the simulator program 310 simulates the presence of target processing circuitry.

The simulator code 310 includes instruction decoding program logic 312, processing program logic 314 and exception control program logic 318 which correspond in functionality to the instruction decoder 10, processing circuitry 4 and exception control circuitry 40 discussed above. Also, a register emulating data structure 316 may be maintained by the simulator code 310 to emulate the registers 14 provided in the instruction set architecture of the target processor which is simulated by the simulator code 310. For example, the register emulating data structure 316 may be stored in the memory of the host data processing apparatus and may include storage locations which store data corresponding to the registers 14, including the registers for storing control information as shown in FIG. 3. The exception control program logic 318 may respond to a simulated exception targeting the target processor represented by the simulator code 310 in a corresponding way to the response to an exception by the exception control circuitry 40 described above, including controlling whether an exception is masked and controlling of trapping based on the trap-masked-exception control information and other control information as discussed above (in the simulation, the exception routing control information can be maintained as part of the register emulating data structure 316). Hence, the simulator code 310 may provide similar advantages to those achieved on the physical hardware implementation of the processing apparatus 2 described in the earlier examples.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to perform data processing in one of a plurality of exception levels supported by the processing circuitry; and
exception control circuitry to control taking of exceptions by the processing circuitry, depending on control information stored in at least one register, the control information including at least:
masking control information settable to one of a masked state and an unmasked state; and
trap-masked-exception control information settable by software to one of an untrapped state and a trapped state;
in which:
in response to a given exception of a maskable class of exceptions which are maskable based the masking control information being in the masked state, the exception control circuitry is configured to:
determine whether the masking control information is in the masked state;
in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and
in a case when the masking control information is in the unmasked state and the given exception is determined not to be masked, select a target exception level for handling the given exception, the target exception level being selected independent of the trap-masked-exception control information.

2. The apparatus according to claim 1, in which:
the control information comprises a plurality of items of trap-masked-exception control information each associated with a respective one of a plurality of predetermined trap target exception levels, and
the exception control circuitry is configured to control whether, in at least one scenario where the given exception occurs when the masking control information is in the masked state and the current exception level is less privileged than a given one of the plurality of predetermined trap target exception levels, the given exception is trapped to the given one of the plurality of predetermined trap target exception levels, depending on whether a corresponding item of trap-masked-exception control information associated with that given one of the plurality of predetermined trap target exception levels is in the trapped state.

3. The apparatus according to claim 2, in which, in at least one scenario where the given exception occurs when the masking control information is in the masked state, at least two items of trap-masked-exception control information are in the trapped state, and one or more conditions for trapping to the predetermined trap target exception level are satisfied for each of said at least two items of trap-masked-exception control information:
the exception control circuitry is configured to trap the given exception to the predetermined trap target exception level associated with a selected item of trap-masked-exception control information; and
the selected item of trap-masked-exception control information comprises one of said at least two items of trap-masked-exception control information for which there is a smallest difference in privilege between the current exception level and the associated predetermined trap target exception level.

4. The apparatus according to claim 1, in which, in a case when the trap-masked-exception control information is in the untrapped state, the exception control circuitry is configured to determine whether the given exception is masked depending at least on whether the masking control information is in the masked state.

5. The apparatus according to claim 4, in which the exception control circuitry is also configured to determine whether the given exception is to be masked depending on whether the current exception level is more privileged than an exception level at which the given exception would be taken if the given exception is taken when the trap-masked-exception control information is in the untrapped state.

6. The apparatus according to claim 4, in which:
the control information comprises non-maskable-exception-control information which is settable to one of a non-maskable state and a maskable state to indicate whether or not exceptions of the maskable class are maskable; and
in at least one scenario when the non-maskable-exception-control information is in the non-maskable state, the exception control circuitry is configured to determine that the given exception is not to be masked, even when the masking control information is set to the masked state.

7. The apparatus according to claim 6, in which in a scenario when the given exception occurs when the current exception level is a least privileged exception level, the non-maskable-exception control information is in the non-maskable state, and the given exception would be taken to a next least privileged exception level that is enabled for taking the given exception in a case when the given exception is not masked and the trap-masked-exception control information is in the untrapped state, the exception control circuitry is configured to:
control taking of the given exception in the next least privileged exception level, without trapping to the predetermined trap target exception level, even when the trap-masked-exception control information is in the trapped state.

8. The apparatus according to claim 7, in which the control information comprises a plurality of items of non-maskable-exception control information associated with different exception levels; and
the exception control circuitry is configured to determine whether the given exception is masked depending on one of the plurality of items of non-maskable-exception-control information selected based on the current exception level.

9. The apparatus according to claim 1, in which the control information comprises at least one further item of trap control information settable by software to one of a trapped state and an untrapped state;
the exception control circuitry is configured to control whether to trap exceptions of at least the maskable class to a particular exception level, depending on whether the further item of trap control information is in the trapped state; and
the at least one further item of trap control information takes precedence over the trap-masked-exception control information, so that in a case when the further item of trap control information is in the trapped state, the exception control circuitry is configured to trap the exception to the particular exception level based on the further item of trap control information regardless of whether the trap-masked-exception control information is in the trapped state.

10. The apparatus according to claim 1, in which the maskable class of exceptions comprises asynchronous error exceptions indicative of a deviation from correct service.

11. The apparatus according to claim 1, in which, in response to a non-maskable exception of a non-maskable class of exceptions which are unable to be masked based on setting the masking control information to the masked state, the exception control circuitry is configured to:
in at least one scenario when the given exception occurs when the masking control information is in the masked state, a current exception level is less privileged than the predetermined trap target exception level associated with the trap-masked-exception control information and the current exception level is an exception level that is capable of being a target exception level for handling exceptions, control whether to trap the non-maskable exception to the predetermined trap target exception level depending on whether the trap-masked-exception control information is in the trapped state.

12. The apparatus according to claim 11, in which the non-maskable class of exceptions comprise synchronous external abort exceptions indicative of a deviation from correct service.

13. The apparatus according to claim 1, comprising a plurality of sets of one or more exception syndrome registers, each set of one or more exception syndrome registers to store exception syndrome information for exceptions taken in a respective one of the exception levels.

14. The apparatus according to claim 1, in which in response to an instruction which requests an update to the trap-masked-exception control information being executed at a less privileged exception level than the predetermined trap target exception level associated with the trap-masked-exception control information, the processing circuitry is configured to reject or trap the requested update to the trap-masked-exception control information.

15. Computer-readable code for fabrication of the apparatus of claim 1.

16. A storage medium storing the computer-readable code of claim 15.

17. A method comprising:
performing data processing in one of a plurality of exception levels supported by the processing circuitry; and
controlling taking of exceptions by the processing circuitry, depending on control information stored in at least one register, the control information including at least:
masking control information settable to one of a masked state and an unmasked state; and
trap-masked-exception control information settable by software to one of an untrapped state and a trapped state;
in which:
in response to a given exception of a maskable class of exceptions which are maskable based on setting the masking control information to the masked state, the method comprises:
determine whether the masking control information is in the masked state;
in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and
in a case when the masking control information is in the unmasked state and the given exception is determined not to be masked, select a target exception level for handling the given exception, the target exception level being selected independent of the trap-masked-exception control information.

18. A computer program comprising instructions which, when executed by a host data processing apparatus, control the host data processing apparatus to provide an instruction execution environment for executing target code, the computer program comprising:
processing program logic to simulate execution of instructions of the target code in one of a plurality of exception levels; and
exception control program logic to simulate taking of exceptions, depending on control information stored in at least one storage location of the host data processing apparatus representing at least one register of a target instruction set architecture used by the target code, the control information including at least:
masking control information settable to one of a masked state and an unmasked state; and
trap-masked-exception control information settable by software to one of an untrapped state and a trapped state;
in which:
in response to a given exception of a maskable class of exceptions which are maskable based on setting the masking control information to the masked state, the exception control program logic is configured to:
determine whether the masking control information is in the masked state;
in at least one scenario when the given exception occurs when the masking control information is in the masked state and a current exception level is less privileged than a predetermined trap target exception level associated with the trap-masked-exception control information, control whether to trap the given exception to the predetermined trap target exception level depending on whether the trap-masked-exception control information is in the trapped state; and
in a case when the masking control information is in the unmasked state and the given exception is determined not to be masked, select a target exception level for handling the given exception, the target exception level being selected independent of the trap-masked-exception control information.

19. A storage medium storing the computer program of claim 18.
